(19) United States
(12) Patent Application Publication
(10) Pub. No.: US 2025/0192967 A1
(43) Pub. Date: Jun. 12, 2025

(54) METHOD AND DEVICE FOR ALLOCATING PLURALITY OF RUS OR MRUS IN ORDER TO SIMULTANEOUSLY TRANSMIT OR RECEIVE PLURALITY OF PSDUS BY ONE RECEPTION STA IN WIRELESS LAN SYSTEM

(71) Applicant: LG ELECTRONICS INC., Seoul (KR)

(72) Inventors: Eunsung PARK, Seoul (KR); Jinyoung CHUN, Seoul (KR); Jinsoo CHOI, Seoul (KR); Dongguk LIM, Seoul (KR); Insun JANG, Seoul (KR); Insik JUNG, Seoul (KR)

(21) Appl. No.: 18/842,317

(22) PCT Filed: Mar. 17, 2023
(86) PCT No.: PCT/KR2023/003596

§ 371 Date: Aug. 28, 2024

(30) Foreign Application Priority Data
Mar. 29, 2022 (KR) 10-2022-0039032

(51) Int. Cl. H04L 5/00; H04B 7/0452; H04B 7/06; H04L 27/26; H04W 84/12

(52) U.S. Cl. CPC H04L 5/0094; H04B 7/0452; H04B 7/0617; H04L 27/2603; H04W 84/12

(57) ABSTRACT

Proposed are a method and a device for allocating a plurality of RUs or MRUs in order to simultaneously transmit or receive a plurality of PSDUs by one reception STA in a wireless LAN system. Specifically, a reception STA receives control information from a transmission STA. The reception STA decodes a plurality of PSDUs included in a PPDU on the basis of the control information. The plurality of PSDUs are simultaneously transmitted through one link. The control information includes information on a plurality of RUs or MRUs to which the plurality of PSDUs are allocated, respectively, within a bandwidth of the PPDU. The plurality of RUs or MRUs are allocated only in a channel within an operation bandwidth of the reception STA.

### CROSS-REFERENCE TO RELATED APPLICATIONS

This application is the National Stage filing under 35 U.S.C. 371 of International Application No. PCT/KR2023/003596, filed on Mar. 17, 2023, which claims the benefit of KR Patent Application No. 10-2022-0039032 filed on Mar. 29, 2022, the contents of which are all hereby incorporated by reference herein in their entirety.

### TECHNICAL FIELD

The present specification relates to a technique for transmitting and receiving multiple PSDUs based on control information related to RUs or MRUs in a wireless LAN system, and more particularly, to a method and apparatus for allocating a plurality of RUs or MRUs so that one receiving STA can simultaneously transmit and receive a plurality of PSDUs.

### BACKGROUND

A wireless local area network (WLAN) has been improved in various ways. For example, the IEEE 802.11ax standard proposed an improved communication environment using orthogonal frequency division multiple access (OFDMA) and downlink multi-user multiple input multiple output (DL MU MIMO) techniques.

The present specification proposes a technical feature that can be utilized in a new communication standard. For example, the new communication standard may be an extreme high throughput (EHT) standard which is currently being discussed. The EHT standard may use an increased bandwidth, an enhanced PHY layer protocol data unit (PPDU) structure, an enhanced sequence, a hybrid automatic repeat request (HARQ) scheme, or the like, which is newly proposed. The EHT standard may be called the IEEE 802.11be standard.

In a new WLAN standard, an increased number of spatial streams may be used. In this case, in order to properly use the increased number of spatial streams, a signaling technique in the WLAN system may need to be improved.

### SUMMARY

The present specification proposes a method and apparatus for allocating a plurality of RUs or MRUs so that one receiving STA can simultaneously transmit and receive a plurality of PSDUs in a wireless LAN system.

An example of the present specification proposes a method for a plurality of RUs or MRUs so that one receiving STA can simultaneously transmit and receive a plurality of PSDUs.

The present embodiment may be performed in a network environment in which a next generation WLAN system (IEEE 802.11be or EHT WLAN system) is supported. The next generation wireless LAN system is a WLAN system that is enhanced from an 802.11ax system and may, therefore, satisfy backward compatibility with the 802.11ax system.

The present embodiment is performed in a transmitting STA, and the transmitting STA may correspond to an access point (AP) or a station (STA). The receiving STA of the present embodiment may correspond to an STA or an AP.

This embodiment proposes a method of allocating RUs or MRUs to each of a plurality of PSDUs when one receiving STA transmits the plurality of PSDUs on one link or when the plurality of PSDUs are transmitted to one receiving STA.

A receiving station (STA) receives control information from a transmitting STA.

The receiving STA decodes a plurality of Physical Service Data Units (PSDUs) included in a Physical Protocol Data Unit (PPDU) based on the control information.

The plurality of PSDUs are transmitted simultaneously on a single link. That is, it is assumed that the transmitting and receiving STAs are capable of only single link operation (not multi-link operation).

The control information includes information on a plurality of Resource Units (RUs) or Multi-Resource Units (MRUs) to which the plurality of PSDUs are respectively allocated within a bandwidth of the PPDU. For example, it is assumed that the plurality of PSDUs include first to third PSDUs, and the plurality of RUs or MRUs include first to third RUs or MRUs. The first PSDU may be allocated to the first RU or MRU, the second PSDU may be allocated to the second RU or MRU, and the third PSDU may be allocated to the third RU or MRU.

The plurality of RUs or MRUs are allocated only within a channel within an operating bandwidth of the receiving STA. That is, the plurality of RUs or MRUs may be allocated only within a channel on which the receiving STA operates within the bandwidth of the PPDU.

That is, the present embodiment proposes a method of setting an RU or MRU for allocating the plurality of PSDUs when one receiving STA transmits the plurality of PSDUs simultaneously or when the plurality of PSDUs are transmitted simultaneously to one receiving STA.

In the past, there was a limitation that a single receiving STA could not simultaneously transmit and receive a plurality of PSDUs through a single link. According to the embodiment proposed in this specification, by allocating a plurality of RUs or MRUs for a transmitting STA to simultaneously transmit and receive the plurality of PSDUs, the channel can be used more efficiently, and the utilization and efficiency of the channel can be improved.

### BRIEF DESCRIPTION OF THE DRAWINGS

FIG. 1 shows an example of a transmitting apparatus and/or receiving apparatus of the present specification.

FIG. 2 is a conceptual view illustrating the structure of a wireless local area network (WLAN).

FIG. 3 illustrates a general link setup process.

FIG. 4 illustrates an example of a PPDU used in an IEEE standard.

FIG. 5 illustrates a layout of resource units (RUs) used in a band of 20 MHz.

FIG. 6 illustrates a layout of RUs used in a band of 40 MHz.

FIG. 7 illustrates a layout of RUs used in a band of 80 MHz.

FIG. 8 illustrates a structure of an HE-SIG-B field.

FIG. 9 illustrates an example in which a plurality of user STAs are allocated to the same RU through a MU-MIMO scheme.

FIG. 10 illustrates an example of a PPDU used in the present specification.

FIG. 11 illustrates an example of a modified transmission device and/or receiving device of the present specification.

FIG. 12 is the 80 MHz tone plan defined in 802.11be.

FIG. 13 shows the format of the HE variant User Info field of the trigger frame.

FIG. 14 shows the format of the EHT variant User Info field of the trigger frame.

FIG. 15 shows an example of transmitting multiple PSDUs to one STA based on an MU PPDU according to the present embodiment.

FIG. 16 shows an example of transmitting multiple PSDUs to one STA based on a trigger frame according to the present embodiment.

FIG. 17 is a procedure flowchart showing the operation of a transmitting device according to the present embodiment.

FIG. 18 is a procedure flowchart showing the operation of a receiving device according to the present embodiment.

FIG. 19 is a flowchart showing a procedure for transmitting a PPDU including multiple PSDUs to one receiving STA according to the present embodiment.

FIG. 20 is a flowchart showing a procedure for receiving a PPDU including multiple PSDUs from a transmitting STA according to the present embodiment.

### DETAILED DESCRIPTION

In the present specification, “A or B” may mean “only A”, “only B” or “both A and B”. In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”.

In addition, in the present specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present specification may mean “for example”. Specifically, when indicated as “control information (EHT-signal)”, it may denote that “EHT-signal” is proposed as an example of the “control information”. In other words, the “control information” of the present specification is not limited to “EHT-signal”, and “EHT-signal” may be proposed as an example of the “control information”. In addition, when indicated as “control information (i.e., EHT-signal)”, it may also mean that “EHT-signal” is proposed as an example of the “control information”.

Technical features described individually in one figure in the present specification may be individually implemented, or may be simultaneously implemented.

The following example of the present specification may be applied to various wireless communication systems. For example, the following example of the present specification may be applied to a wireless local area network (WLAN) system. For example, the present specification may be applied to the IEEE 802.11a/g/n/ac standard or the IEEE 802.11ax standard. In addition, the present specification may also be applied to the newly proposed EHT standard or IEEE 802.11be standard. In addition, the example of the present specification may also be applied to a new WLAN standard enhanced from the EHT standard or the IEEE 802.11be standard. In addition, the example of the present specification may be applied to a mobile communication system. For example, it may be applied to a mobile communication system based on long term evolution (LTE) depending on a 3^{rd} generation partnership project (3GPP) standard and based on evolution of the LTE. In addition, the example of the present specification may be applied to a communication system of a 5G NR standard based on the 3GPP standard.

Hereinafter, in order to describe a technical feature of the present specification, a technical feature applicable to the present specification will be described.

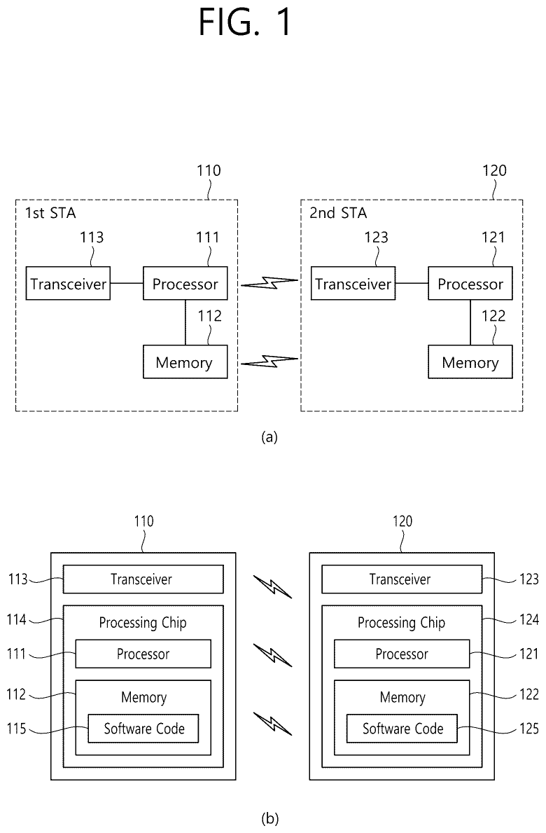

FIG. 1 shows an example of a transmitting apparatus and/or receiving apparatus of the present specification.

In the example of FIG. 1, various technical features described below may be performed. FIG. 1 relates to at least one station (STA). For example, STAs 110 and 120 of the present specification may also be called in various terms such as a mobile terminal, a wireless device, a wireless transmit/receive unit (WTRU), a user equipment (UE), a mobile station (MS), a mobile subscriber unit, or simply a user. The STAs 110 and 120 of the present specification may also be called in various terms such as a network, a base station, a node-B, an access point (AP), a repeater, a router, a relay, or the like. The STAs 110 and 120 of the present specification may also be referred to as various names such as a receiving apparatus, a transmitting apparatus, a receiving STA, a transmitting STA, a receiving device, a transmitting device, or the like.

For example, the STAs 110 and 120 may serve as an AP or a non-AP. That is, the STAs 110 and 120 of the present specification may serve as the AP and/or the non-AP.

The STAs 110 and 120 of the present specification may support various communication standards together in addition to the IEEE 802.11 standard. For example, a communication standard (e.g., LTE, LTE-A, 5G NR standard) or the like based on the 3GPP standard may be supported. In addition, the STA of the present specification may be implemented as various devices such as a mobile phone, a vehicle, a personal computer, or the like. In addition, the STA of the present specification may support communication for various communication services such as voice calls, video calls, data communication, and self-driving (autonomous-driving), or the like.

The STAs 110 and 120 of the present specification may include a medium access control (MAC) conforming to the IEEE 802.11 standard and a physical layer interface for a radio medium.

The STAs 110 and 120 will be described below with reference to a sub-figure (a) of FIG. 1.

The first STA 110 may include a processor 111, a memory 112, and a transceiver 113. The illustrated process, memory, and transceiver may be implemented individually as separate chips, or at least two blocks/functions may be implemented through a single chip.

The transceiver 113 of the first STA performs a signal transmission/reception operation. Specifically, an IEEE 802.11 packet (e.g., IEEE 802.11a/b/g/n/ac/ax/be, etc.) may be transmitted/received.

For example, the first STA 110 may perform an operation intended by an AP. For example, the processor 111 of the AP may receive a signal through the transceiver 113, process a reception (RX) signal, generate a transmission (TX) signal, and provide control for signal transmission. The memory 112 of the AP may store a signal (e.g., RX signal) received through the transceiver 113, and may store a signal (e.g., TX signal) to be transmitted through the transceiver.

For example, the second STA 120 may perform an operation intended by a non-AP STA. For example, a transceiver 123 of a non-AP performs a signal transmission/reception operation. Specifically, an IEEE 802.11 packet (e.g., IEEE 802.11a/b/g/n/ac/ax/be packet, etc.) may be transmitted/received.

For example, a processor 121 of the non-AP STA may receive a signal through the transceiver 123, process an RX signal, generate a TX signal, and provide control for signal transmission. A memory 122 of the non-AP STA may store a signal (e.g., RX signal) received through the transceiver 123, and may store a signal (e.g., TX signal) to be transmitted through the transceiver.

For example, an operation of a device indicated as an AP in the specification described below may be performed in the first STA 110 or the second STA 120. For example, if the first STA 110 is the AP, the operation of the device indicated as the AP may be controlled by the processor 111 of the first STA 110, and a related signal may be transmitted or received through the transceiver 113 controlled by the processor 111 of the first STA 110. In addition, control information related to the operation of the AP or a TX/RX signal of the AP may be stored in the memory 112 of the first STA 110. In addition, if the second STA 120 is the AP, the operation of the device indicated as the AP may be controlled by the processor 121 of the second STA 120, and a related signal may be transmitted or received through the transceiver 123 controlled by the processor 121 of the second STA 120. In addition, control information related to the operation of the AP or a TX/RX signal of the AP may be stored in the memory 122 of the second STA 120.

For example, in the specification described below, an operation of a device indicated as a non-AP (or user-STA) may be performed in the first STA 110 or the second STA 120. For example, if the second STA 120 is the non-AP, the operation of the device indicated as the non-AP may be controlled by the processor 121 of the second STA 120, and a related signal may be transmitted or received through the transceiver 123 controlled by the processor 121 of the second STA 120. In addition, control information related to the operation of the non-AP or a TX/RX signal of the non-AP may be stored in the memory 122 of the second STA 120. For example, if the first STA 110 is the non-AP, the operation of the device indicated as the non-AP may be controlled by the processor 111 of the first STA 110, and a related signal may be transmitted or received through the transceiver 113 controlled by the processor 111 of the first STA 110. In addition, control information related to the operation of the non-AP or a TX/RX signal of the non-AP may be stored in the memory 112 of the first STA 110.

In the specification described below, a device called a (transmitting/receiving) STA, a first STA, a second STA, a STA1, a STA2, an AP, a first AP, a second AP, an AP1, an AP2, a (transmitting/receiving) terminal, a (transmitting/receiving) device, a (transmitting/receiving) apparatus, a network, or the like may imply the STAs 110 and 120 of FIG. 1. For example, a device indicated as, without a specific reference numeral, the (transmitting/receiving) STA, the first STA, the second STA, the STA1, the STA2, the AP, the first AP, the second AP, the AP1, the AP2, the (transmitting/receiving) terminal, the (transmitting/receiving) device, the (transmitting/receiving) apparatus, the network, or the like may imply the STAs 110 and 120 of FIG. 1. For example, in the following example, an operation in which various STAs transmit/receive a signal (e.g., a PPDU) may be performed in the transceivers 113 and 123 of FIG. 1. In addition, in the following example, an operation in which various STAs generate a TX/RX signal or perform data processing and computation in advance for the TX/RX signal may be performed in the processors 111 and 121 of FIG. 1. For example, an example of an operation for generating the TX/RX signal or performing the data processing and computation in advance may include: 1) an operation of determining/obtaining/configuring/computing/decoding/encoding bit information of a sub-field (SIG, STF, LTF, Data) included in a PPDU; 2) an operation of determining/configuring/obtaining a time resource or frequency resource (e.g., a subcarrier resource) or the like used for the sub-field (SIG, STF, LTF, Data) included the PPDU; 3) an operation of determining/configuring/obtaining a specific sequence (e.g., a pilot sequence, an STF/LTF sequence, an extra sequence applied to SIG) or the like used for the sub-field (SIG, STF, LTF, Data) field included in the PPDU; 4) a power control operation and/or power saving operation applied for the STA; and 5) an operation related to determining/obtaining/configuring/decoding/encoding or the like of an ACK signal. In addition, in the following example, a variety of information used by various STAs for determining/obtaining/configuring/computing/decoding/decoding a TX/RX signal (e.g., information related to a field/subfield/control field/parameter/power or the like) may be stored in the memories 112 and 122 of FIG. 1.

The aforementioned device/STA of the sub-figure (a) of FIG. 1 may be modified as shown in the sub-figure (b) of FIG. 1. Hereinafter, the STAs 110 and 120 of the present specification will be described based on the sub-figure (b) of FIG. 1.

For example, the transceivers 113 and 123 illustrated in the sub-figure (b) of FIG. 1 may perform the same function as the aforementioned transceiver illustrated in the sub-figure (a) of FIG. 1. For example, processing chips 114 and 124 illustrated in the sub-figure (b) of FIG. 1 may include the processors 111 and 121 and the memories 112 and 122. The processors 111 and 121 and memories 112 and 122 illustrated in the sub-figure (b) of FIG. 1 may perform the same function as the aforementioned processors 111 and 121 and memories 112 and 122 illustrated in the sub-figure (a) of FIG. 1.

A mobile terminal, a wireless device, a wireless transmit/receive unit (WTRU), a user equipment (UE), a mobile station (MS), a mobile subscriber unit, a user, a user STA, a network, a base station, a Node-B, an access point (AP), a repeater, a router, a relay, a receiving unit, a transmitting unit, a receiving STA, a transmitting STA, a receiving device, a transmitting device, a receiving apparatus, and/or a transmitting apparatus, which are described below, may imply the STAs 110 and 120 illustrated in the sub-figure (a)/(b) of FIG. 1, or may imply the processing chips 114 and 124 illustrated in the sub-figure (b) of FIG. 1. That is, a technical feature of the present specification may be performed in the STAs 110 and 120 illustrated in the sub-figure (a)/(b) of FIG. 1, or may be performed only in the processing chips 114 and 124 illustrated in the sub-figure (b) of FIG. 1. For example, a technical feature in which the transmitting STA transmits a control signal may be understood as a technical feature in which a control signal generated in the processors 111 and 121 illustrated in the sub-figure (a)/(b) of FIG. 1 is transmitted through the transceivers 113 and 123 illustrated in the sub-figure (a)/(b) of FIG. 1. Alternatively, the technical feature in which the transmitting STA transmits the control signal may be understood as a technical feature in which the control signal to be transferred to the transceivers 113 and 123 is generated in the processing chips 114 and 124 illustrated in the sub-figure (b) of FIG. 1.

For example, a technical feature in which the receiving STA receives the control signal may be understood as a technical feature in which the control signal is received by means of the transceivers 113 and 123 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (a) of FIG. 1 is obtained by the processors 111 and 121 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (b) of FIG. 1 is obtained by the processing chips 114 and 124 illustrated in the sub-figure (b) of FIG. 1.

Referring to the sub-figure (b) of FIG. 1, software codes 115 and 125 may be included in the memories 112 and 122. The software codes 115 and 126 may include instructions for controlling an operation of the processors 111 and 121. The software codes 115 and 125 may be included as various programming languages.

The processors 111 and 121 or processing chips 114 and 124 of FIG. 1 may include an application-specific integrated circuit (ASIC), other chipsets, a logic circuit and/or a data processing device. The processor may be an application processor (AP). For example, the processors 111 and 121 or processing chips 114 and 124 of FIG. 1 may include at least one of a digital signal processor (DSP), a central processing unit (CPU), a graphics processing unit (GPU), and a modulator and demodulator (modem). For example, the processors 111 and 121 or processing chips 114 and 124 of FIG. 1 may be SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or processors enhanced from these processors.

In the present specification, an uplink may imply a link for communication from a non-AP STA to an SP STA, and an uplink PPDU/packet/signal or the like may be transmitted through the uplink. In addition, in the present specification, a downlink may imply a link for communication from the AP STA to the non-AP STA, and a downlink PPDU/packet/signal or the like may be transmitted through the downlink.

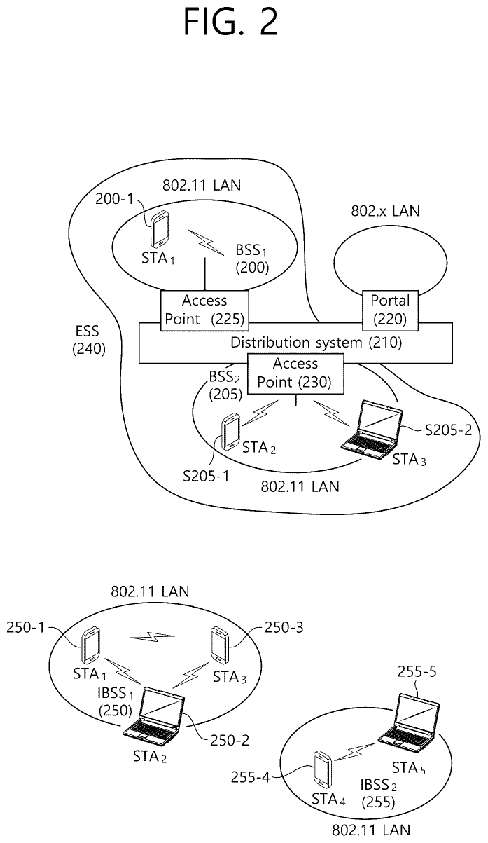

FIG. 2 is a conceptual view illustrating the structure of a wireless local area network (WLAN).

An upper part of FIG. 2 illustrates the structure of an infrastructure basic service set (BSS) of institute of electrical and electronic engineers (IEEE) 802.11.

Referring the upper part of FIG. 2, the wireless LAN system may include one or more infrastructure BSSs 200 and 205 (hereinafter, referred to as BSS). The BSSs 200 and 205 as a set of an AP and a STA such as an access point (AP) 225 and a station (STA1) 200-1 which are successfully synchronized to communicate with each other are not concepts indicating a specific region. The BSS 205 may include one or more STAs 205-1 and 205-2 which may be joined to one AP 230.

The BSS may include at least one STA, APs providing a distribution service, and a distribution system (DS) 210 connecting multiple APs.

The distribution system 210 may implement an extended service set (ESS) 240 extended by connecting the multiple BSSs 200 and 205. The ESS 240 may be used as a term indicating one network configured by connecting one or more APs 225 or 230 through the distribution system 210. The AP included in one ESS 240 may have the same service set identification (SSID).

A portal 220 may serve as a bridge which connects the wireless LAN network (IEEE 802.11) and another network (e.g., 802.X).

In the BSS illustrated in the upper part of FIG. 2, a network between the APs 225 and 230 and a network between the APs 225 and 230 and the STAs 200-1, 205-1, and 205-2 may be implemented. However, the network is configured even between the STAs without the APs 225 and 230 to perform communication. A network in which the communication is performed by configuring the network even between the STAs without the APs 225 and 230 is defined as an Ad-Hoc network or an independent basic service set (IBSS).

A lower part of FIG. 2 illustrates a conceptual view illustrating the IBSS.

Referring to the lower part of FIG. 2, the IBSS is a BSS that operates in an Ad-Hoc mode. Since the IBSS does not include the access point (AP), a centralized management entity that performs a management function at the center does not exist. That is, in the IBSS, STAs 250-1, 250-2, 250-3, 255-4, and 255-5 are managed by a distributed manner. In the IBSS, all STAs 250-1, 250-2, 250-3, 255-4, and 255-5 may be constituted by movable STAs and are not permitted to access the DS to constitute a self-contained network.

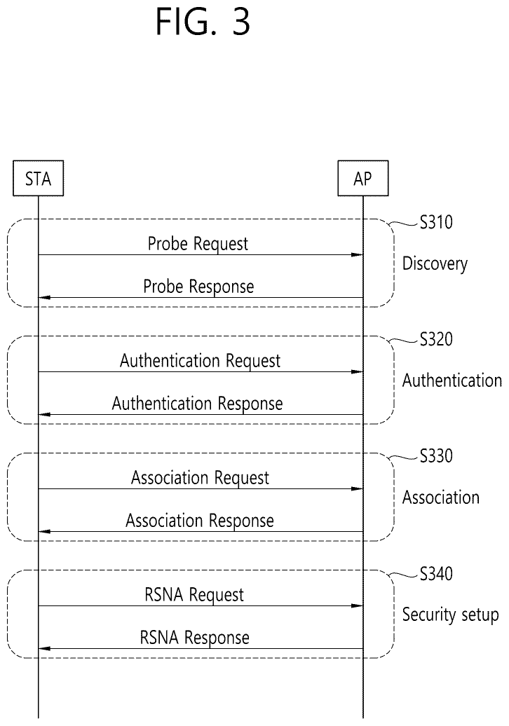

FIG. 3 illustrates a general link setup process.

In S310, a STA may perform a network discovery operation. The network discovery operation may include a scanning operation of the STA. That is, to access a network, the STA needs to discover a participating network. The STA needs to identify a compatible network before participating in a wireless network, and a process of identifying a network present in a particular area is referred to as scanning. Scanning methods include active scanning and passive scanning.

FIG. 3 illustrates a network discovery operation including an active scanning process. In active scanning, a STA performing scanning transmits a probe request frame and waits for a response to the probe request frame in order to identify which AP is present around while moving to channels. A responder transmits a probe response frame as a response to the probe request frame to the STA having transmitted the probe request frame. Here, the responder may be a STA that transmits the last beacon frame in a BSS of a channel being scanned. In the BSS, since an AP transmits a beacon frame, the AP is the responder. In an IBSS, since STAs in the IBSS transmit a beacon frame in turns, the responder is not fixed. For example, when the STA transmits a probe request frame via channel 1 and receives a probe response frame via channel 1, the STA may store BSS-related information included in the received probe response frame, may move to the next channel (e.g., channel 2), and may perform scanning (e.g., transmits a probe request and receives a probe response via channel 2) by the same method.

Although not shown in FIG. 3, scanning may be performed by a passive scanning method. In passive scanning, a STA performing scanning may wait for a beacon frame while moving to channels. A beacon frame is one of management frames in IEEE 802.11 and is periodically transmitted to indicate the presence of a wireless network and to enable the STA performing scanning to find the wireless network and to participate in the wireless network. In a BSS, an AP serves to periodically transmit a beacon frame. In an IBSS, STAs in the IBSS transmit a beacon frame in turns. Upon receiving the beacon frame, the STA performing scanning stores information related to a BSS included in the beacon frame and records beacon frame information in each channel while moving to another channel. The STA having received the beacon frame may store BSS-related information included in the received beacon frame, may move to the next channel, and may perform scanning in the next channel by the same method.

After discovering the network, the STA may perform an authentication process in S320. The authentication process may be referred to as a first authentication process to be clearly distinguished from the following security setup operation in S340. The authentication process in S320 may include a process in which the STA transmits an authentication request frame to the AP and the AP transmits an authentication response frame to the STA in response. The authentication frames used for an authentication request/response are management frames.

The authentication frames may include information related to an authentication algorithm number, an authentication transaction sequence number, a status code, a challenge text, a robust security network (RSN), and a finite cyclic group.

The STA may transmit the authentication request frame to the AP. The AP may determine whether to allow the authentication of the STA based on the information included in the received authentication request frame. The AP may provide the authentication processing result to the STA via the authentication response frame.

When the STA is successfully authenticated, the STA may perform an association process in S330. The association process includes a process in which the STA transmits an association request frame to the AP and the AP transmits an association response frame to the STA in response. The association request frame may include, for example, information related to various capabilities, a beacon listen interval, a service set identifier (SSID), a supported rate, a supported channel, RSN, a mobility domain, a supported operating class, a traffic indication map (TIM) broadcast request, and an interworking service capability. The association response frame may include, for example, information related to various capabilities, a status code, an association ID (AID), a supported rate, an enhanced distributed channel access (EDCA) parameter set, a received channel power indicator (RCPI), a received signal-to-noise indicator (RSNI), a mobility domain, a timeout interval (association comeback time), an overlapping BSS scanning parameter, a TIM broadcast response, and a QoS map.

In S340, the STA may perform a security setup process. The security setup process in S340 may include a process of setting up a private key through four-way handshaking, for example, through an extensible authentication protocol over LAN (EAPOL) frame.

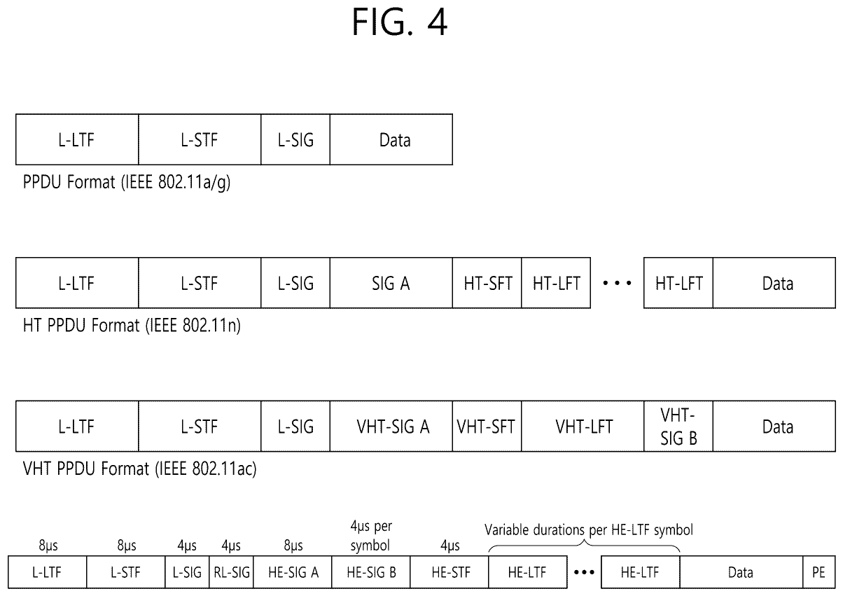

FIG. 4 illustrates an example of a PPDU used in an IEEE standard.

As illustrated, various types of PHY protocol data units (PPDUs) are used in IEEE a/g/n/ac standards. Specifically, an LTF and a STF include a training signal, a SIG-A and a SIG-B include control information for a receiving STA, and a data field includes user data corresponding to a PSDU (MAC PDU/aggregated MAC PDU).

FIG. 4 also includes an example of an HE PPDU according to IEEE 802.11ax. The HE PPDU according to FIG. 4 is an illustrative PPDU for multiple users. An HE-SIG-B may be included only in a PPDU for multiple users, and an HE-SIG-B may be omitted in a PPDU for a single user.

As illustrated in FIG. 4, the HE-PPDU for multiple users (MUs) may include a legacy-short training field (L-STF), a legacy-long training field (L-LTF), a legacy-signal (L-SIG), a high efficiency-signal A (HE-SIG A), a high efficiency-signal-B (HE-SIG B), a high efficiency-short training field (HE-STF), a high efficiency-long training field (HE-LTF), a data field (alternatively, an MAC payload), and a packet extension (PE) field. The respective fields may be transmitted for illustrated time periods (i.e., 4 or 8 μs).

Hereinafter, a resource unit (RU) used for a PPDU is described. An RU may include a plurality of subcarriers (or tones). An RU may be used to transmit a signal to a plurality of STAs according to OFDMA. Further, an RU may also be defined to transmit a signal to one STA. An RU may be used for an STF, an LTF, a data field, or the like.

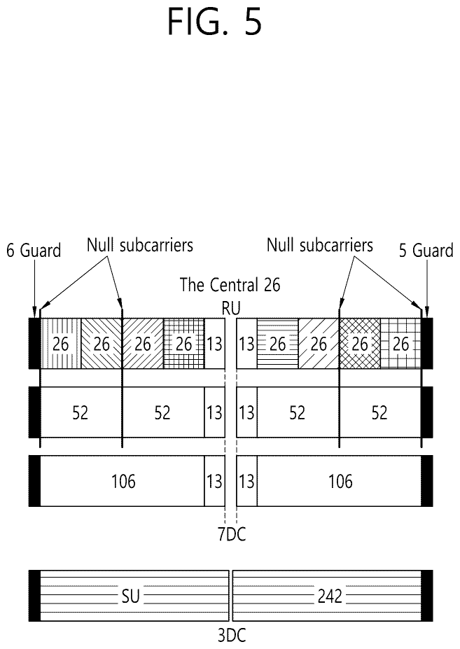

FIG. 5 illustrates a layout of resource units (RUs) used in a band of 20 MHz.

As illustrated in FIG. 5, resource units (RUs) corresponding to different numbers of tones (i.e., subcarriers) may be used to form some fields of an HE-PPDU. For example, resources may be allocated in illustrated RUs for an HE-STF, an HE-LTF, and a data field.

As illustrated in the uppermost part of FIG. 5, a 26-unit (i.e., a unit corresponding to 26 tones) may be disposed. Six tones may be used for a guard band in the leftmost band of the 20 MHz band, and five tones may be used for a guard band in the rightmost band of the 20 MHz band. Further, seven DC tones may be inserted in a center band, that is, a DC band, and a 26-unit corresponding to 13 tones on each of the left and right sides of the DC band may be disposed. A 26-unit, a 52-unit, and a 106-unit may be allocated to other bands. Each unit may be allocated for a receiving STA, that is, a user.

The layout of the RUs in FIG. 5 may be used not only for a multiple users (MUs) but also for a single user (SU), in which case one 242-unit may be used and three DC tones may be inserted as illustrated in the lowermost part of FIG. 5.

Although FIG. 5 proposes RUs having various sizes, that is, a 26-RU, a 52-RU, a 106-RU, and a 242-RU, specific sizes of RUs may be extended or increased. Therefore, the present embodiment is not limited to the specific size of each RU (i.e., the number of corresponding tones).

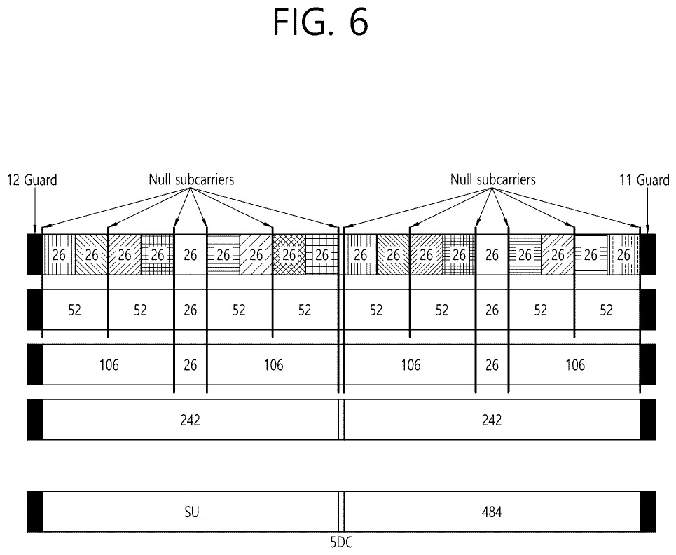

FIG. 6 illustrates a layout of RUs used in a band of 40 MHz.

Similarly to FIG. 5 in which RUs having various sizes are used, a 26-RU, a 52-RU, a 106-RU, a 242-RU, a 484-RU, and the like may be used in an example of FIG. 6. Further, five DC tones may be inserted in a center frequency, 12 tones may be used for a guard band in the leftmost band of the 40 MHz band, and 11 tones may be used for a guard band in the rightmost band of the 40 MHz band.

As illustrated in FIG. 6, when the layout of the RUs is used for a single user, a 484-RU may be used. The specific number of RUs may be changed similarly to FIG. 5.

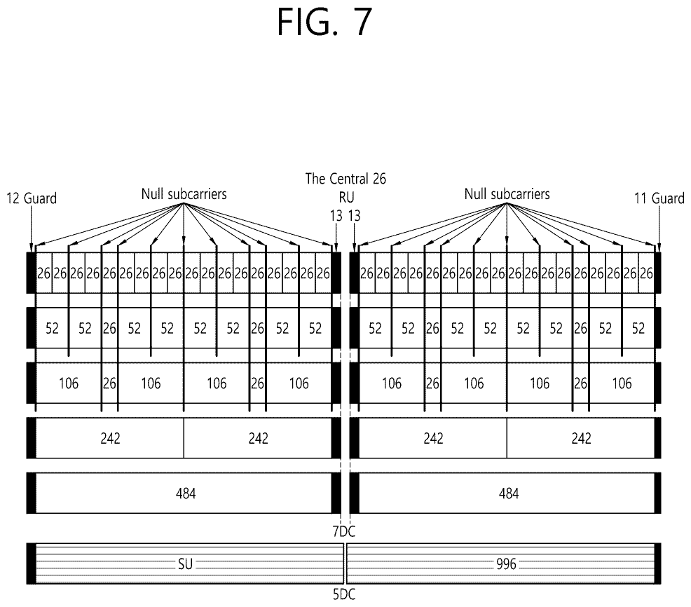

FIG. 7 illustrates a layout of RUs used in a band of 80 MHz.

Similarly to FIG. 5 and FIG. 6 in which RUs having various sizes are used, a 26-RU, a 52-RU, a 106-RU, a 242-RU, a 484-RU, a 996-RU, and the like may be used in an example of FIG. 7. Further, seven DC tones may be inserted in the center frequency, 12 tones may be used for a guard band in the leftmost band of the 80 MHz band, and 11 tones may be used for a guard band in the rightmost band of the 80 MHz band. In addition, a 26-RU corresponding to 13 tones on each of the left and right sides of the DC band may be used.

As illustrated in FIG. 7, when the layout of the RUs is used for a single user, a 996-RU may be used, in which case five DC tones may be inserted.

The RU described in the present specification may be used in uplink (UL) communication and downlink (DL) communication. For example, when UL-MU communication which is solicited by a trigger frame is performed, a transmitting STA (e.g., an AP) may allocate a first RU (e.g., 26/52/106/242-RU, etc.) to a first STA through the trigger frame, and may allocate a second RU (e.g., 26/52/106/242-RU, etc.) to a second STA. Thereafter, the first STA may transmit a first trigger-based PPDU based on the first RU, and the second STA may transmit a second trigger-based PPDU based on the second RU. The first/second trigger-based PPDU is transmitted to the AP at the same (or overlapped) time period.

For example, when a DL MU PPDU is configured, the transmitting STA (e.g., AP) may allocate the first RU (e.g., 26/52/106/242-RU. etc.) to the first STA, and may allocate the second RU (e.g., 26/52/106/242-RU, etc.) to the second STA. That is, the transmitting STA (e.g., AP) may transmit HE-STF, HE-LTF, and Data fields for the first STA through the first RU in one MU PPDU, and may transmit HE-STF, HE-LTF, and Data fields for the second STA through the second RU.

Information related to a layout of the RU may be signaled through HE-SIG-B.

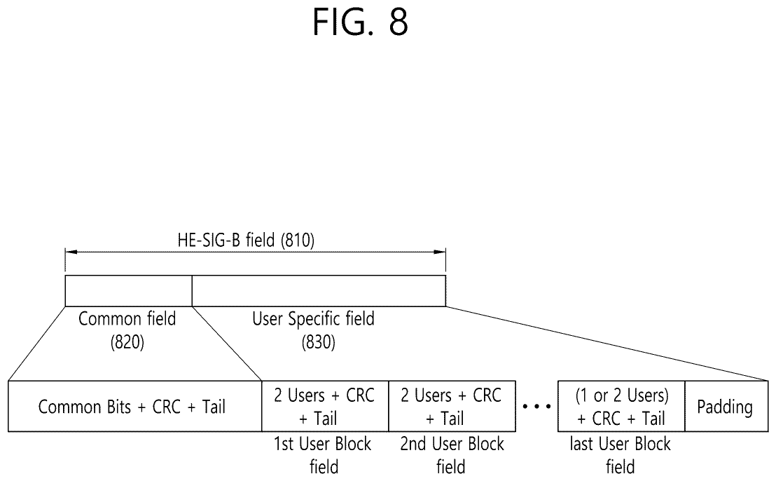

FIG. 8 illustrates a structure of an HE-SIG-B field.

As illustrated, an HE-SIG-B field 810 includes a common field 820 and a user-specific field 830. The common field 820 may include information commonly applied to all users (i.e., user STAs) which receive SIG-B. The user-specific field 830 may be called a user-specific control field. When the SIG-B is transferred to a plurality of users, the user-specific field 830 may be applied only any one of the plurality of users.

As illustrated in FIG. 8, the common field 820 and the user-specific field 830 may be separately encoded.

The common field 820 may include RU allocation information of N*8 bits. For example, the RU allocation information may include information related to a location of an RU. For example, when a 20 MHz channel is used as shown in FIG. 5, the RU allocation information may include information related to a specific frequency band to which a specific RU (26-RU/52-RU/106-RU) is arranged.

An example of a case in which the RU allocation information consists of 8 bits is as follows.

TABLE 1

| RU Allocation | | | | | | | | | | |
|---|---|---|---|---|---|---|---|---|---|---|
| subfield | | | | | | | | | | |
| (B7 B6 B5 B4 | | | | | | | | | | Number |
| B3 B2 B1 B0) | #1 | #2 | #3 | #4 | #5 | #6 | #7 | #8 | #9 | of entries |
| 00000000 | 26 | 26 | 26 | 26 | 26 | 26 | 26 | 26 | 26 | 1 |

| | | | | | | | | | |
|---|---|---|---|---|---|---|---|---|---|
| 00000001 | 26 | 26 | 26 | 26 | 26 | 26 | 26 | 52 | 1 |

| | | | | | | | | | |
|---|---|---|---|---|---|---|---|---|---|
| 00000010 | 26 | 26 | 26 | 26 | 26 | 52 | 26 | 26 | 1 |

| | | | | | | | | |
|---|---|---|---|---|---|---|---|---|
| 00000011 | 26 | 26 | 26 | 26 | 26 | 52 | 52 | 1 |

| | | | | | | | | | |
|---|---|---|---|---|---|---|---|---|---|
| 00000100 | 26 | 26 | 52 | 26 | 26 | 26 | 26 | 26 | 1 |

| | | | | | | | | |
|---|---|---|---|---|---|---|---|---|
| 00000101 | 26 | 26 | 52 | 26 | 26 | 26 | 52 | 1 |

| | | | | | | | | |
|---|---|---|---|---|---|---|---|---|
| 00000110 | 26 | 26 | 52 | 26 | 52 | 26 | 26 | 1 |

| | | | | | | | |
|---|---|---|---|---|---|---|---|
| 00000111 | 26 | 26 | 52 | 26 | 52 | 52 | 1 |

| | | | | | | | | | |
|---|---|---|---|---|---|---|---|---|---|
| 00001000 | 52 | 26 | 26 | 26 | 26 | 26 | 26 | 26 | 1 |

| | | | | | | | | |
|---|---|---|---|---|---|---|---|---|
| 00001001 | 52 | 26 | 26 | 26 | 26 | 26 | 52 | 1 |

| | | | | | | | | |
|---|---|---|---|---|---|---|---|---|
| 00001010 | 52 | 26 | 26 | 26 | 52 | 26 | 26 | 1 |

As shown the example of FIG. 5, up to nine 26-RUs may be allocated to the 20 MHz channel. When the RU allocation information of the common field 820 is set to “00000000” as shown in Table 1, the nine 26-RUs may be allocated to a corresponding channel (i.e., 20 MHz). In addition, when the RU allocation information of the common field 820 is set to “00000001” as shown in Table 1, seven 26-RUs and one 52-RU are arranged in a corresponding channel. That is, in the example of FIG. 5, the 52-RU may be allocated to the rightmost side, and the seven 26-RUs may be allocated to the left thereof.

The example of Table 1 shows only some of RU locations capable of displaying the RU allocation information.

For example, the RU allocation information may include an example of Table 2 below.

TABLE 2

| 8 bits indices | | | | | | | | | | |
|---|---|---|---|---|---|---|---|---|---|---|
| (B7 B6 B5 B4 | | | | | | | | | | Number |
| B3 B2 B1 B0) | #1 | #2 | #3 | #4 | #5 | #6 | #7 | #8 | #9 | of entries |

| | | | | | | | |
|---|---|---|---|---|---|---|---|
| 01000y2y1y0 | 106 | 26 | 26 | 26 | 26 | 26 | 8 |

| | | | | | | |
|---|---|---|---|---|---|---|
| 01001y2y1y0 | 106 | 26 | 26 | 26 | 52 | 8 |

“01000y2y1y0” relates to an example in which a 106-RU is allocated to the leftmost side of the 20 MHz channel, and five 26-RUs are allocated to the right side thereof. In this case, a plurality of STAs (e.g., user-STAs) may be allocated to the 106-RU, based on a MU-MIMO scheme. Specifically, up to 8 STAs (e.g., user-STAs) may be allocated to the 106-RU, and the number of STAs (e.g., user-STAs) allocated to the 106-RU is determined based on 3-bit information (y2y1y0). For example, when the 3-bit information (y2y1y0) is set to N, the number of STAs (e.g., user-STAs) allocated to the 106-RU based on the MU-MIMO scheme may be N+1.

In general, a plurality of STAs (e.g., user STAs) different from each other may be allocated to a plurality of RUs. However, the plurality of STAs (e.g., user STAs) may be allocated to one or more RUs having at least a specific size (e.g., 106 subcarriers), based on the MU-MIMO scheme.

As shown in FIG. 8, the user-specific field 830 may include a plurality of user fields. As described above, the number of STAs (e.g., user STAs) allocated to a specific channel may be determined based on the RU allocation information of the common field 820. For example, when the RU allocation information of the common field 820 is “00000000”, one user STA may be allocated to each of nine 26-RUs (e.g., nine user STAs may be allocated). That is, up to 9 user STAs may be allocated to a specific channel through an OFDMA scheme. In other words, up to 9 user STAs may be allocated to a specific channel through a non-MU-MIMO scheme.

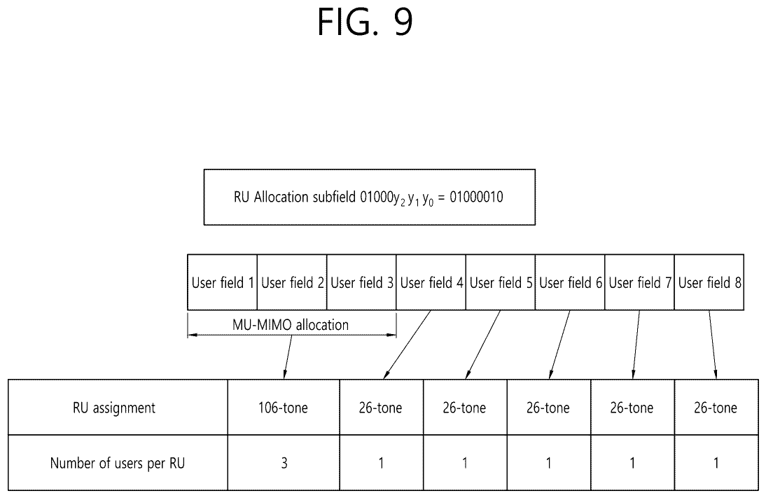

For example, when RU allocation is set to “O1000y2y1y0”, a plurality of STAs may be allocated to the 106-RU arranged at the leftmost side through the MU-MIMO scheme, and five user STAs may be allocated to five 26-RUs arranged to the right side thereof through the non-MU MIMO scheme. This case is specified through an example of FIG. 9.

FIG. 9 illustrates an example in which a plurality of user STAs are allocated to the same RU through a MU-MIMO scheme.

For example, when RU allocation is set to “01000010” as shown in FIG. 9, a 106-RU may be allocated to the leftmost side of a specific channel, and five 26-RUs may be allocated to the right side thereof. In addition, three user STAs may be allocated to the 106-RU through the MU-MIMO scheme. As a result, since eight user STAs are allocated, the user-specific field 830 of HE-SIG-B may include eight user fields.

The eight user fields may be expressed in the order shown in FIG. 9. In addition, as shown in FIG. 8, two user fields may be implemented with one user block field.

The user fields shown in FIG. 8 and FIG. 9 may be configured based on two formats. That is, a user field related to a MU-MIMO scheme may be configured in a first format, and a user field related to a non-MIMO scheme may be configured in a second format. Referring to the example of FIG. 9, a user field 1 to a user field 3 may be based on the first format, and a user field 4 to a user field 8 may be based on the second format. The first format or the second format may include bit information of the same length (e.g., 21 bits).

Each user field may have the same size (e.g., 21 bits). For example, the user field of the first format (the first of the MU-MIMO scheme) may be configured as follows.

For example, a first bit (i.e., B0-B10) in the user field (i.e., 21 bits) may include identification information (e.g., STA-ID, partial AID, etc.) of a user STA to which a corresponding user field is allocated. In addition, a second bit (i.e., B11-B14) in the user field (i.e., 21 bits) may include information related to a spatial configuration.

In addition, a third bit (i.e., B15-18) in the user field (i.e., 21 bits) may include modulation and coding scheme (MCS) information. The MCS information may be applied to a data field in a PPDU including corresponding SIG-B.

An MCS, MCS information, an MCS index, an MCS field, or the like used in the present specification may be indicated by an index value. For example, the MCS information may be indicated by an index 0 to an index 11. The MCS information may include information related to a constellation modulation type (e.g., BPSK, QPSK, 16-QAM, 64-QAM, 256-QAM, 1024-QAM, etc.) and information related to a coding rate (e.g., 1/2, 2/3, 3/4, 5/6e, etc.). Information related to a channel coding type (e.g., LCC or LDPC) may be excluded in the MCS information.

In addition, a fourth bit (i.e., B19) in the user field (i.e., 21 bits) may be a reserved field.

In addition, a fifth bit (i.e., B20) in the user field (i.e., 21 bits) may include information related to a coding type (e.g., BCC or LDPC). That is, the fifth bit (i.e., B20) may include information related to a type (e.g., BCC or LDPC) of channel coding applied to the data field in the PPDU including the corresponding SIG-B.

The aforementioned example relates to the user field of the first format (the format of the MU-MIMO scheme). An example of the user field of the second format (the format of the non-MU-MIMO scheme) is as follows.

A first bit (e.g., B0-B10) in the user field of the second format may include identification information of a user STA. In addition, a second bit (e.g., B11-B13) in the user field of the second format may include information related to the number of spatial streams applied to a corresponding RU. In addition, a third bit (e.g., B14) in the user field of the second format may include information related to whether a beamforming steering matrix is applied. A fourth bit (e.g., B15-B18) in the user field of the second format may include modulation and coding scheme (MCS) information. In addition, a fifth bit (e.g., B19) in the user field of the second format may include information related to whether dual carrier modulation (DCM) is applied. In addition, a sixth bit (i.e., B20) in the user field of the second format may include information related to a coding type (e.g., BCC or LDPC).

Hereinafter, a PPDU transmitted/received in a STA of the present specification will be described.

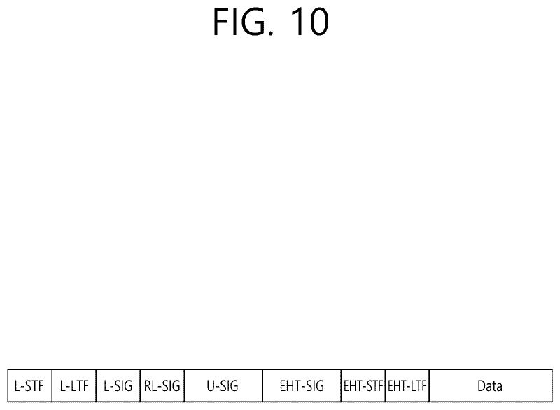

FIG. 10 illustrates an example of a PPDU used in the present specification.

The PPDU of FIG. 10 may be called in various terms such as an EHT PPDU, a TX PPDU, an RX PPDU, a first type or N-th type PPDU, or the like. For example, in the present specification, the PPDU or the EHT PPDU may be called in various terms such as a TX PPDU, a RX PPDU, a first type or N-th type PPDU, or the like. In addition, the EHT PPDU may be used in an EHT system and/or a new WLAN system enhanced from the EHT system.

The PPDU of FIG. 10 may indicate the entirety or part of a PPDU type used in the EHT system. For example, the example of FIG. 10 may be used for both of a single-user (SU) mode and a multi-user (MU) mode. In other words, the PPDU of FIG. 10 may be a PPDU for one receiving STA or a plurality of receiving STAs. When the PPDU of FIG. 10 is used for a trigger-based (TB) mode, the EHT-SIG of FIG. 10 may be omitted. In other words, an STA which has received a trigger frame for uplink-MU (UL-MU) may transmit the PPDU in which the EHT-SIG is omitted in the example of FIG. 10.

In FIG. 10, an L-STF to an EHT-LTF may be called a preamble or a physical preamble, and may be generated/transmitted/received/obtained/decoded in a physical layer.

A subcarrier spacing of the L-STF, L-LTF, L-SIG, RL-SIG, U-SIG, and EHT-SIG fields of FIG. 10 may be determined as 312.5 kHz, and a subcarrier spacing of the EHT-STF, EHT-LTF, and Data fields may be determined as 78.125 kHz. That is, a tone index (or subcarrier index) of the L-STF, L-LTF, L-SIG, RL-SIG, U-SIG, and EHT-SIG fields may be expressed in unit of 312.5 kHz, and a tone index (or subcarrier index) of the EHT-STF, EHT-LTF, and Data fields may be expressed in unit of 78.125 kHz.

In the PPDU of FIG. 10, the L-LTE and the L-STF may be the same as those in the conventional fields.

The L-SIG field of FIG. 10 may include, for example, bit information of 24 bits. For example, the 24-bit information may include a rate field of 4 bits, a reserved bit of 1 bit, a length field of 12 bits, a parity bit of 1 bit, and a tail bit of 6 bits. For example, the length field of 12 bits may include information related to a length or time duration of a PPDU. For example, the length field of 12 bits may be determined based on a type of the PPDU. For example, when the PPDU is a non-HT, HT, VHT PPDU or an EHT PPDU, a value of the length field may be determined as a multiple of 3. For example, when the PPDU is an HE PPDU, the value of the length field may be determined as “a multiple of 3”+1 or “a multiple of 3”+2. In other words, for the non-HT, HT, VHT PPDI or the EHT PPDU, the value of the length field may be determined as a multiple of 3, and for the HE PPDU, the value of the length field may be determined as “a multiple of 3”+1 or “a multiple of 3”+2.

For example, the transmitting STA may apply BCC encoding based on a 1/2 coding rate to the 24-bit information of the L-SIG field. Thereafter, the transmitting STA may obtain a BCC coding bit of 48 bits. BPSK modulation may be applied to the 48-bit coding bit, thereby generating 48 BPSK symbols. The transmitting STA may map the 48 BPSK symbols to positions except for a pilot subcarrier {subcarrier index −21, −7, +7, +21} and a DC subcarrier{subcarrier index 0}. As a result, the 48 BPSK symbols may be mapped to subcarrier indices −26 to −22, −20 to −8, −6 to −1, +1 to +6, +8 to +20, and +22 to +26. The transmitting STA may additionally map a signal of {−1, −1, −1, 1} to a subcarrier index{−28, −27, +27, +28}. The aforementioned signal may be used for channel estimation on a frequency domain corresponding to {−28, −27, +27, +28}.

The transmitting STA may generate an RL-SIG generated in the same manner as the L-SIG. BPSK modulation may be applied to the RL-SIG. The receiving STA may know that the RX PPDU is the HE PPDU or the EHT PPDU, based on the presence of the RL-SIG.

A universal SIG (U-SIG) may be inserted after the RL-SIG of FIG. 10. The U-SIB may be called in various terms such as a first SIG field, a first SIG, a first type SIG, a control signal, a control signal field, a first (type) control signal, or the like.

The U-SIG may include information of N bits, and may include information for identifying a type of the EHT PPDU. For example, the U-SIG may be configured based on two symbols (e.g., two contiguous OFDM symbols). Each symbol (e.g., OFDM symbol) for the U-SIG may have a duration of 4 μs. Each symbol of the U-SIG may be used to transmit the 26-bit information. For example, each symbol of the U-SIG may be transmitted/received based on 52 data tomes and 4 pilot tones.

Through the U-SIG (or U-SIG field), for example, A-bit information (e.g., 52 un-coded bits) may be transmitted. A first symbol of the U-SIG may transmit first X-bit information (e.g., 26 un-coded bits) of the A-bit information, and a second symbol of the U-SIB may transmit the remaining Y-bit information (e.g. 26 un-coded bits) of the A-bit information. For example, the transmitting STA may obtain 26 un-coded bits included in each U-SIG symbol. The transmitting STA may perform convolutional encoding (i.e., BCC encoding) based on a rate of R=1/2 to generate 52-coded bits, and may perform interleaving on the 52-coded bits. The transmitting STA may perform BPSK modulation on the interleaved 52-coded bits to generate 52 BPSK symbols to be allocated to each U-SIG symbol. One U-SIG symbol may be transmitted based on 65 tones (subcarriers) from a subcarrier index −28 to a subcarrier index +28, except for a DC index 0. The 52 BPSK symbols generated by the transmitting STA may be transmitted based on the remaining tones (subcarriers) except for pilot tones, i.e., tones −21, −7, +7, +21.

For example, the A-bit information (e.g., 52 un-coded bits) generated by the U-SIG may include a CRC field (e.g., a field having a length of 4 bits) and a tail field (e.g., a field having a length of 6 bits). The CRC field and the tail field may be transmitted through the second symbol of the U-SIG. The CRC field may be generated based on 26 bits allocated to the first symbol of the U-SIG and the remaining 16 bits except for the CRC/tail fields in the second symbol, and may be generated based on the conventional CRC calculation algorithm. In addition, the tail field may be used to terminate trellis of a convolutional decoder, and may be set to, for example, “000000”.

The A-bit information (e.g., 52 un-coded bits) transmitted by the U-SIG (or U-SIG field) may be divided into version-independent bits and version-dependent bits. For example, the version-independent bits may have a fixed or variable size. For example, the version-independent bits may be allocated only to the first symbol of the U-SIG, or the version-independent bits may be allocated to both of the first and second symbols of the U-SIG. For example, the version-independent bits and the version-dependent bits may be called in various terms such as a first control bit, a second control bit, or the like.

For example, the version-independent bits of the U-SIG may include a PHY version identifier of 3 bits. For example, the PHY version identifier of 3 bits may include information related to a PHY version of a TX/RX PPDU. For example, a first value of the PHY version identifier of 3 bits may indicate that the TX/RX PPDU is an EHT PPDU. In other words, when the transmitting STA transmits the EHT PPDU, the PHY version identifier of 3 bits may be set to a first value. In other words, the receiving STA may determine that the RX PPDU is the EHT PPDU, based on the PHY version identifier having the first value.

For example, the version-independent bits of the U-SIG may include a UL/DL flag field of 1 bit. A first value of the UL/DL flag field of 1 bit relates to UL communication, and a second value of the UL/DL flag field relates to DL communication.

For example, the version-independent bits of the U-SIG may include information related to a TXOP length and information related to a BSS color ID.

For example, when the EHT PPDU is divided into various types (e.g., various types such as an EHT PPDU related to an SU mode, an EHT PPDU related to a MU mode, an EHT PPDU related to a TB mode, an EHT PPDU related to extended range transmission, or the like), information related to the type of the EHT PPDU may be included in the version-dependent bits of the U-SIG.

For example, the U-SIG may include: 1) a bandwidth field including information related to a bandwidth; 2) a field including information related to an MCS scheme applied to EHT-SIG; 3) an indication field including information regarding whether a dual subcarrier modulation (DCM) scheme is applied to EHT-SIG; 4) a field including information related to the number of symbol used for EHT-SIG; 5) a field including information regarding whether the EHT-SIG is generated across a full band; 6) a field including information related to a type of EHT-LTF/STF; and 7) information related to a field indicating an EHT-LTF length and a CP length.

Preamble puncturing may be applied to the PPDU of FIG. 10. The preamble puncturing implies that puncturing is applied to part (e.g., a secondary 20 MHz band) of the full band. For example, when an 80 MHz PPDU is transmitted, an STA may apply puncturing to the secondary 20 MHz band out of the 80 MHz band, and may transmit a PPDU only through a primary 20 MHz band and a secondary 40 MHz band.

For example, a pattern of the preamble puncturing may be configured in advance. For example, when a first puncturing pattern is applied, puncturing may be applied only to the secondary 20 MHz band within the 80 MHz band. For example, when a second puncturing pattern is applied, puncturing may be applied to only any one of two secondary 20 MHz bands included in the secondary 40 MHz band within the 80 MHz band. For example, when a third puncturing pattern is applied, puncturing may be applied to only the secondary 20 MHz band included in the primary 80 MHz band within the 160 MHz band (or 80+80 MHz band). For example, when a fourth puncturing is applied, puncturing may be applied to at least one 20 MHz channel not belonging to a primary 40 MHz band in the presence of the primary 40 MHz band included in the 80 MHaz band within the 160 MHz band (or 80+80 MHz band).

Information related to the preamble puncturing applied to the PPDU may be included in U-SIG and/or EHT-SIG. For example, a first field of the U-SIG may include information related to a contiguous bandwidth, and second field of the U-SIG may include information related to the preamble puncturing applied to the PPDU.

For example, the U-SIG and the EHT-SIG may include the information related to the preamble puncturing, based on the following method. When a bandwidth of the PPDU exceeds 80 MHz, the U-SIG may be configured individually in unit of 80 MHz. For example, when the bandwidth of the PPDU is 160 MHz, the PPDU may include a first U-SIG for a first 80 MHz band and a second U-SIG for a second 80 MHz band. In this case, a first field of the first U-SIG may include information related to a 160 MHz bandwidth, and a second field of the first U-SIG may include information related to a preamble puncturing (i.e., information related to a preamble puncturing pattern) applied to the first 80 MHz band. In addition, a first field of the second U-SIG may include information related to a 160 MHz bandwidth, and a second field of the second U-SIG may include information related to a preamble puncturing (i.e., information related to a preamble puncturing pattern) applied to the second 80 MHz band. Meanwhile, an EHT-SIG contiguous to the first U-SIG may include information related to a preamble puncturing applied to the second 80 MHz band (i.e., information related to a preamble puncturing pattern), and an EHT-SIG contiguous to the second U-SIG may include information related to a preamble puncturing (i.e., information related to a preamble puncturing pattern) applied to the first 80 MHz band.

Additionally or alternatively, the U-SIG and the EHT-SIG may include the information related to the preamble puncturing, based on the following method. The U-SIG may include information related to a preamble puncturing (i.e., information related to a preamble puncturing pattern) for all bands. That is, the EHT-SIG may not include the information related to the preamble puncturing, and only the U-SIG may include the information related to the preamble puncturing (i.e., the information related to the preamble puncturing pattern).

The U-SIG may be configured in unit of 20 MHz. For example, when an 80 MHz PPDU is configured, the U-SIG may be duplicated. That is, four identical U-SIGs may be included in the 80 MHz PPDU. PPDUs exceeding an 80 MHz bandwidth may include different U-SIGs.

The EHT-SIG of FIG. 10 may include control information for the receiving STA. The EHT-SIG may be transmitted through at least one symbol, and one symbol may have a length of 4 μs. Information related to the number of symbols used for the EHT-SIG may be included in the U-SIG.

The EHT-SIG may include a technical feature of the HE-SIG-B described with reference to FIG. 8 and FIG. 9. For example, the EHT-SIG may include a common field and a user-specific field as in the example of FIG. 8. The common field of the EHT-SIG may be omitted, and the number of user-specific fields may be determined based on the number of users.

As in the example of FIG. 8, the common field of the EHT-SIG and the user-specific field of the EHT-SIG may be individually coded. One user block field included in the user-specific field may include information for two users, but a last user block field included in the user-specific field may include information for one user. That is, one user block field of the EHT-SIG may include up to two user fields. As in the example of FIG. 9, each user field may be related to MU-MIMO allocation, or may be related to non-MU-MIMO allocation.

As in the example of FIG. 8, the common field of the EHT-SIG may include a CRC bit and a tail bit. A length of the CRC bit may be determined as 4 bits. A length of the tail bit may be determined as 6 bits, and may be set to ‘000000’.

As in the example of FIG. 8, the common field of the EHT-SIG may include RU allocation information. The RU allocation information may imply information related to a location of an RU to which a plurality of users (i.e., a plurality of receiving STAs) are allocated. The RU allocation information may be configured in unit of 8 bits (or N bits), as in Table 1.

A mode in which the common field of the EHT-SIG is omitted may be supported. The mode in the common field of the EHT-SIG is omitted may be called a compressed mode. When the compressed mode is used, a plurality of users (i.e., a plurality of receiving STAs) may decode the PPDU (e.g., the data field of the PPDU), based on non-OFDMA. That is, the plurality of users of the EHT PPDU may decode the PPDU (e.g., the data field of the PPDU) received through the same frequency band. Meanwhile, when a non-compressed mode is used, the plurality of users of the EHT PPDU may decode the PPDU (e.g., the data field of the PPDU), based on OFDMA. That is, the plurality of users of the EHT PPDU may receive the PPDU (e.g., the data field of the PPDU) through different frequency bands.

The EHT-SIG may be configured based on various MCS schemes. As described above, information related to an MCS scheme applied to the EHT-SIG may be included in U-SIG. The EHT-SIG may be configured based on a DCM scheme. For example, among N data tones (e.g., 52 data tones) allocated for the EHT-SIG, a first modulation scheme may be applied to half of consecutive tones, and a second modulation scheme may be applied to the remaining half of the consecutive tones. That is, a transmitting STA may use the first modulation scheme to modulate specific control information through a first symbol and allocate it to half of the consecutive tones, and may use the second modulation scheme to modulate the same control information by using a second symbol and allocate it to the remaining half of the consecutive tones. As described above, information (e.g., a 1-bit field) regarding whether the DCM scheme is applied to the EHT-SIG may be included in the U-SIG. The EHT-STF of FIG. 10 may be used for improving automatic gain control estimation in a multiple input multiple output (MIMO) environment or an OFDMA environment. The EHT-LTF of FIG. 10 may be used for estimating a channel in the MIMO environment or the OFDMA environment.

Information related to a type of STF and/or LTF (information related to a GI applied to LTF is also included) may be included in a SIG-A field and/or SIG-B field or the like of FIG. 10.

A PPDU (e.g., EHT-PPDU) of FIG. 10 may be configured based on the example of FIG. 5 and FIG. 6.

For example, an EHT PPDU transmitted on a 20 MHz band, i.e., a 20 MHz EHT PPDU, may be configured based on the RU of FIG. 5. That is, a location of an RU of EHT-STF, EHT-LTF, and data fields included in the EHT PPDU may be determined as shown in FIG. 5.

An EHT PPDU transmitted on a 40 MHz band, i.e., a 40 MHz EHT PPDU, may be configured based on the RU of FIG. 6. That is, a location of an RU of EHT-STF, EHT-LTF, and data fields included in the EHT PPDU may be determined as shown in FIG. 6.

Since the RU location of FIG. 6 corresponds to 40 MHz, a tone-plan for 80 MHz may be determined when the pattern of FIG. 6 is repeated twice. That is, an 80 MHz EHT PPDU may be transmitted based on a new tone-plan in which not the RU of FIG. 7 but the RU of FIG. 6 is repeated twice.

When the pattern of FIG. 6 is repeated twice, 23 tones (i.e., 11 guard tones+12 guard tones) may be configured in a DC region. That is, a tone-plan for an 80 MHz EHT PPDU allocated based on OFDMA may have 23 DC tones. Unlike this, an 80 MHz EHT PPDU allocated based on non-OFDMA (i.e., a non-OFDMA full bandwidth 80 MHz PPDU) may be configured based on a 996-RU, and may include 5 DC tones, 12 left guard tones, and 11 right guard tones.

A tone-plan for 160/240/320 MHz may be configured in such a manner that the pattern of FIG. 6 is repeated several times.

The PPDU of FIG. 10 may be determined (or identified) as an EHT PPDU based on the following method.

A receiving STA may determine a type of an RX PPDU as the EHT PPDU, based on the following aspect. For example, the RX PPDU may be determined as the EHT PPDU: 1) when a first symbol after an L-LTF signal of the RX PPDU is a BPSK symbol; 2) when RL-SIG in which the L-SIG of the RX PPDU is repeated is detected; and 3) when a result of applying “modulo 3” to a value of a length field of the L-SIG of the RX PPDU is detected as “0”. When the RX PPDU is determined as the EHT PPDU, the receiving STA may detect a type of the EHT PPDU (e.g., an SU/MU/Trigger-based/Extended Range type), based on bit information included in a symbol after the RL-SIG of FIG. 10. In other words, the receiving STA may determine the RX PPDU as the EHT PPDU, based on: 1) a first symbol after an L-LTF signal, which is a BPSK symbol; 2) RL-SIG contiguous to the L-SIG field and identical to L-SIG; 3) L-SIG including a length field in which a result of applying “modulo 3” is set to “0”; and 4) a 3-bit PHY version identifier of the aforementioned U-SIG (e.g., a PHY version identifier having a first value).

For example, the receiving STA may determine the type of the RX PPDU as the EHT PPDU, based on the following aspect. For example, the RX PPDU may be determined as the HE PPDU: 1) when a first symbol after an L-LTF signal is a BPSK symbol; 2) when RL-SIG in which the L-SIG is repeated is detected; and 3) when a result of applying “modulo 3” to a value of a length field of the L-SIG is detected as “1” or “2”.

For example, the receiving STA may determine the type of the RX PPDU as a non-HT, HT, and VHT PPDU, based on the following aspect. For example, the RX PPDU may be determined as the non-HT, HT, and VHT PPDU: 1) when a first symbol after an L-LTF signal is a BPSK symbol; and 2) when RL-SIG in which L-SIG is repeated is not detected. In addition, even if the receiving STA detects that the RL-SIG is repeated, when a result of applying “modulo 3” to the length value of the L-SIG is detected as “0”, the RX PPDU may be determined as the non-HT, HT, and VHT PPDU.

In the following example, a signal represented as a (TX/RX/UL/DL) signal, a (TX/RX/UL/DL) frame, a (TX/RX/UL/DL) packet, a (TX/RX/UL/DL) data unit, (TX/RX/UL/DL) data, or the like may be a signal transmitted/received based on the PPDU of FIG. 10. The PPDU of FIG. 10 may be used to transmit/receive frames of various types. For example, the PPDU of FIG. 10 may be used for a control frame. An example of the control frame may include a request to send (RTS), a clear to send (CTS), a power save-poll (PS-poll), BlockACKReq, BlockAck, a null data packet (NDP) announcement, and a trigger frame. For example, the PPDU of FIG. 10 may be used for a management frame. An example of the management frame may include a beacon frame, a (re-)association request frame, a (re-)association response frame, a probe request frame, and a probe response frame. For example, the PPDU of FIG. 10 may be used for a data frame. For example, the PPDU of FIG. 10 may be used to simultaneously transmit at least two or more of the control frames, the management frame, and the data frame.

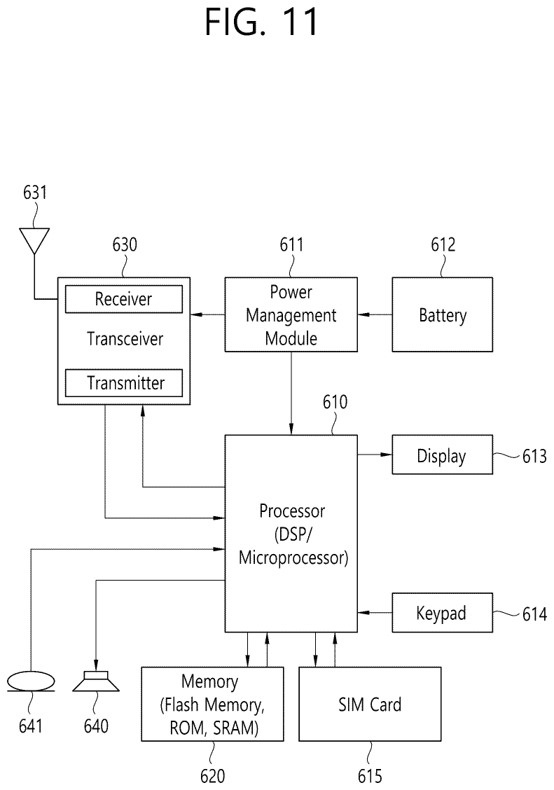

FIG. 11 illustrates an example of a modified transmission device and/or receiving device of the present specification.

Each device/STA of the sub-figure (a)/(b) of FIG. 1 may be modified as shown in FIG. 11. A transceiver 630 of FIG. 11 may be identical to the transceivers 113 and 123 of FIG. 1. The transceiver 630 of FIG. 11 may include a receiver and a transmitter.

A processor 610 of FIG. 11 may be identical to the processors 111 and 121 of FIG. 1. Alternatively, the processor 610 of FIG. 11 may be identical to the processing chips 114 and 124 of FIG. 1.

A memory 620 of FIG. 11 may be identical to the memories 112 and 122 of FIG. 1. Alternatively, the memory 620 of FIG. 11 may be a separate external memory different from the memories 112 and 122 of FIG. 1.

Referring to FIG. 11, a power management module 611 manages power for the processor 610 and/or the transceiver 630. A battery 612 supplies power to the power management module 611. A display 613 outputs a result processed by the processor 610. A keypad 614 receives inputs to be used by the processor 610. The keypad 614 may be displayed on the display 613. A SIM card 615 may be an integrated circuit which is used to securely store an international mobile subscriber identity (IMSI) and its related key, which are used to identify and authenticate subscribers on mobile telephony devices such as mobile phones and computers.

Referring to FIG. 11, a speaker 640 may output a result related to a sound processed by the processor 610. A microphone 641 may receive an input related to a sound to be used by the processor 610.

### 1. Definitions for U-SIG and EHT-SIG

The specific description of U-SIG and EHT-SIG defined in the 802.11be wireless LAN system is as follows.

The U-SIG field conveys information necessary for interpreting the EHT PPDU. The integer field of the U-SIG field is transmitted in unsigned binary format with the Least Significant Bit (LSB) first, where the LSB is in the lowest numbered bit position.

The table below shows the configuration of U-SIG in the EHT MU PPDU.

TABLE 3

| Two parts | | | Number | |
|---|---|---|---|---|
| of U-SIG | Bit | Field | of bits | Description |
| U-SIG-1 | B0-B2 | PHY Version Identifier | 3 | Differentiate between different PHY clauses. |
| | | | | Set to 0 for EHT. |
| | | | | Values 1-7 are Validate. |
| | B3-B5 | Bandwidth | 3 | Set to 0 for 20 MHz. |
| | | | | Set to 1 for 40 MHz. |
| | | | | Set to 2 for 80 MHz. |
| | | | | Set to 3 for 160 MHz. |
| | | | | Set to 4 for 320 MHz-1. |
| | | | | Set to 5 for 320 MHz-2. |
| | | | | Values 6 and 7 arc Validate. |
| | B6 | UL/DL | 1 | Indicates whether the PPDU is sent in UL or |
| | | | | DL. Set to the TXVECTOR parameter |
| | | | | UPLINK_FLAG. |
| | | | | A value of 1 indicates the PPDU is |
| | | | | addressed to an AP. |
| | | | | A value of 0 indicates the PPDU is |
| | | | | addressed to a non-AP STA. |
| | B7-B12 | BSS Color | 6 | An identifier of the BSS. |
| | | | | Set to the TXVECTOR parameter |
| | | | | BSS_COLOR. |
| | B13-B19 | TXOP | 7 | If the TXVECTOR parameter |
| | | | | TXOP_DURATION is UNSPECIFIED, set to |
| | | | | 127 to indicate the absence of duration |
| | | | | information. |
| | | | | If the TXVECTOR parameter |
| | | | | TXOP_DURATION is an integer value, set to |
| | | | | a value less than 127 to indicate duration |
| | | | | information for NAV setting and protection of |
| | | | | the TXOP as follows: |
| | | | | If the TXVECTOR parameter TXO- |
| | | | | P_DURATION is less than 512, set to |
| | | | | 2 × floor(TXOP_DURATION/8). |
| | | | | Otherwise, set to |
| | | | | 2 × floor((TXOP_DURATION − 512)/ |
| | | | | 128) + 1. |
| | B20-B24 | Disregard | 5 | Set to all 1s and treat as Disregard. |
| | B25 | Validate | 1 | Set to 1 and treat as Validate. |
| U-SIG-2 | B0-B1 | PPDU Type And | 2 | If the UL/DL field is set to 0: |
| | | Compression Mode | | A value of 0 indicates a DL OFDMA |
| | | | | transmission. |
| | | | | A value of 1 indicates a transmission to a |
| | | | | single user or an EHT sounding NDP. |
| | | | | A value of 2 indicates a non-OFDMA DL |
| | | | | MU-MIMO transmission. |
| | | | | A value of 3 is Validate. |
| | | | | If the UL/DL field is set to 1: |
| | | | | A value of 1 indicates a transmission to a |
| | | | | single user or an EHT sounding NDP. |
| | | | | Values 2 and 3 are Validate. |
| | | | | NOTE-A value of 0 indicates a TB |
| | | | | PPDU. |
| | | | | For further clarifications on all values of |
| | | | | this field, refer to Table 9 (Combination of |
| | | | | UL/DL and PPDU Type And Compression |
| | | | | Mode field). |
| | B2 | Validate | 1 | Set to 1 and treat as Validate. |
| | B3-B7 | Punctured Channel | 5 | If the PPDU Type And Compression Mode |
| | | Information | | field is set to 1 regardless of the value of the |
| | | | | UL/DL field, or the PPDU Type And |
| | | | | Compression Mode field is set to 2 and the |
| | | | | UL/DL field is 0: |
| | | | | Indicates the puncturing information of |
| | | | | this non-OFDMA transmission. See |
| | | | | Table 10 (Definition of the Punctured |
| | | | | Channel Information field in the U-SIG |
| | | | | for an EHT MU PPDU using non- |
| | | | | OFDMA transmissions) for the |
| | | | | definition. Undefined values of this field |
| | | | | are Validate. |
| | | | | If the PPDU Type And Compression Mode |
| | | | | field is set to 0 and the UL/DL field is 0: |
| | | | | If the Bandwidth field is set to a valuc |
| | | | | between 2 and 5, which indicates an |
| | | | | 80 MHz, 160 MHz or 320 MHz PPDU, |
| | | | | then B3-B6 is a 4-bit bitmap that |
| | | | | indicates which 20 MHz subchannel is |
| | | | | punctured in the 80 MHz frequency |
| | | | | subblock where U-SIG processing is |
| | | | | performed. The 4-bit bitmap is indexed |
| | | | | by the 20 MHz subchannels in ascending |
| | | | | order with B3 indicating the lowest |
| | | | | frequency 20 MHz subchannel. For each |
| | | | | of the bits B3-B6, a value of 0 indicates |
| | | | | that the corresponding 20 MHz channel |
| | | | | is punctured, and a value of 1 is used |
| | | | | otherwise. The following allowed |
| | | | | punctured patterns (B3-B6) are defined |
| | | | | for an 80 MHz frequency subblock: 1111 |
| | | | | (no puncturing), 0111, 1011, 1101, 1110, |
| | | | | 0011, 1100, and 1001. Any field values |
| | | | | other than the allowed punctured patterns |
| | | | | are Validate. Field value may be varied |
| | | | | from one 80 MHz to the other. |
| | | | | If the Bandwidth field is set to 0 or 1, |
| | | | | which indicates a 20/40 MHz PPDU, |
| | | | | B3-B6 are set to all ls. Other values are |
| | | | | Validate. |
| | | | | B7 is set to 1 and Disregard. |
| | B8 | Validate | 1 | Set to 1 and treat as Validate. |
| | B9-B10 | EHT-SIG MCS | 2 | Indicates the MCS used for modulating the |
| | | | | EHT-SIG. |
| | | | | Set to 0 for EHT-MCS 0. |
| | | | | Set to 1 for EHT-MCS 1. |
| | | | | Set to 2 for EHT-MCS 3. |
| | | | | Set to 3 for EHT-MCS 15. |
| | B11-B15 | Number Of EHT-SIG | 5 | Indicates the number of EHT-SIG symbols. |
| | | Symbols | | Set to a value that is the number of EHT-SIG |
| | | | | symbols minus 1. This value shall be the same |
| | | | | in every 80 MHz frequency subblock. |
| | B16-B19 | CRC | 4 | CRC for bits 0-41 of the U-SIG field. Bits 0- |
| | | | | 41 of the U-SIG field correspond to bits 0-25 |
| | | | | of U-SIG-1 field followed by bits 0-15 of U- |
| | | | | SIG-2 field. |
| | B20-B25 | Tail | 6 | Used to terminate the trellis of the |
| | | | | convolutional decoder. Set to 0. |

The EHT-SIG field provides additional signaling to the U-SIG field to enable STAs to interpret the EHT MU PPDU. In an EHT MU PPDU, the EHT-SIG field contains the U-SIG overflow bit, which is common to all users. The EHT-SIG field further contains resource allocation information, which allows STAs to query the resources to be used in the EHT modulated field of the PPDU. The integer fields of the EHT-SIG field are transmitted in unsigned binary format, LSB first, where the LSB is in the lowest numbered bit position.

The EHT-SIG field of a 20 MHz EHT MU PPDU contains one EHT-SIG content channel. For OFDMA transmission and non-OFDMA transmission to multiuser, the EHT-SIG field of an EHT MU PPDU of 40 MHz or 80 MHz contains two EHT-SIG content channels. For OFDMA transmission and non-OFDMA transmission to multiuser, the EHT-SIG field of an EHT MU PPDU of 160 MHz or higher contains two EHT-SIG content channels per 80 MHz frequency subblock. The EHT-SIG content channel per 80 MHz frequency subblock can convey different information when the bandwidth of the EHT MU PPDU for OFDMA transmission is wider than 80 MHz. The EHT-SIG field of an EHT SU transmission or the EHT-SIG field of an EHT sounding NDP contains one EHT-SIG content channel, which is replicated on each non-punctured 20 MHz subchannel when the EHT PPDU is 40 MHz or longer.

For EHT MU PPDUs, except for EHT Sounding NDP, each EHT-SIG content channel consists of common fields and user-specific fields. For EHT Sounding NDP, there are no user-specific fields and the EHT-SIG content channel consists of only common fields.

The table below shows the configuration of the RU Allocation subfield included in the common field of EHT-SIG in an EHT MU PPDU that performs OFDMA transmission.

TABLE 4

| | | | Number of | |
|---|---|---|---|---|
| | | Number of | bits per | |
| Bit | Subfield | subfields | subfield | Description |
| B17- | RU Allocation-A | N | 9 | N RU Allocation-A subfields are present in |
| B16 + 9N | | | | an EHT-SIG content channel, where: |
| | | | | N is set to 1 if the Bandwidth field in the U- |
| | | | | SIG field is equal to 0 or 1. |
| | | | | N is set to 2 if the Bandwidth field in the U- |
| | | | | SIG field is equal to 2, 3, 4, or 5. |
| | | | | Each RU Allocation-A subfield in an EHT- |
| | | | | SIG content channel corresponding to a |
| | | | | 20 MHz frequency subchannel indicates the |
| | | | | RU or MRU assignment, including the size |
| | | | | of the RU(s) or MRU(s) and their placement |
| | | | | in the frequency domain, to be used in the |
| | | | | EHT modulated fields of the EHT MU PPDU |
| | | | | in the frequency domain, where the |
| | | | | subcarrier indices of the RU(s) or MRU(s) |
| | | | | meet the conditions in Table 6 (RUs or |
| | | | | MRUs associated with each RU Allocation. |
| | | | | subfield for each EHT-SIG content channel |
| | | | | and PPDU bandwidth). Lach RU Allocation- |
| | | | | A subfield also indicates information needed |
| | | | | to compute the number of users allocated to |
| | | | | each of these RU(s) or MRU(s). |
| B27 + 9N- | RU Allocation-B | M | 9 | M RU Allocation-B subfields are present in |
| B26 + 9N + 9M | | | | an EHT-SIG content channel if the |
| | | | | Bandwidth subfield in the U-SIG field |
| | | | | indicates a 160 MHz, 320 MHz-1, or |
| | | | | 320 MHz-2 EHT MU PPDU where M is |
| | | | | equal to 2 of 6 as follows: |
| | | | | M is set to 2 if the Bandwidth field in the U- |
| | | | | SIG field is 3. |
| | | | | M is set to 6 if the Bandwidth field in the U- |
| | | | | SIG field is 4 or 5. |
| | | | | The subfields are not present otherwise (i.e., |
| | | | | M is equal to 0). |
| | | | | Each RU Allocation-B subfield in an EHT- |
| | | | | SIG content channel corresponding to a |
| | | | | 20 MHz frequency subchannel indicates the |
| | | | | RU or MRU assignment, including the size |
| | | | | of the RU(s) or MRU(s) and their placement |
| | | | | in the frequency domain, to be used in the |
| | | | | EHT modulated fields of the EHT MU PPDU |
| | | | | in the frequency domain, where the |
| | | | | subcarrier indices of the RU(s) or MRU(s) |
| | | | | meet the conditions in Table 6 (RUs or |
| | | | | MRUs associated with each RU Allocation |
| | | | | subfield for each EHT-SIG content channel |
| | | | | and PPDU bandwidth). Each RU Allocation- |
| | | | | B subfield also indicates information needed |
| | | | | to compute the number of users allocated to. |
| | | | | each of these RU(s) or MRU(s). |

The mapping, from the 9-bit RU Allocation subfield to the number of user fields per RU or MRU contributing to RU allocation and user-specific fields of the same EHT-SIG content channel is defined by the RU Allocation subfield as shown in the table below.

TABLE 5

| RU Allocation subfield | | | | | | | | | | |
|---|---|---|---|---|---|---|---|---|---|---|
| (B8 B7 B6 B5 B4 B3 B2 | | | | | | | | | | Number |
| B1 B0) | 1 | 2 | 3 | 4 | 5 | 6 | 7 | 8 | 9 | of entries |
| 0 (000000000) | 26 | 26 | 26 | 26 | 26 | 26 | 26 | 26 | 26 | 1 |

| | | | | | | | | | |
|---|---|---|---|---|---|---|---|---|---|
| 1 (000000001) | 26 | 26 | 26 | 26 | 26 | 26 | 26 | 52 | 1 |

| | | | | | | | | | |
|---|---|---|---|---|---|---|---|---|---|
| 2 (000000010) | 26 | 26 | 26 | 26 | 26 | 52 | 26 | 26 | 1 |

| | | | | | | | | |
|---|---|---|---|---|---|---|---|---|
| 3 (000000011) | 26 | 26 | 26 | 26 | 26 | 52 | 52 | 1 |

| | | | | | | | | | |
|---|---|---|---|---|---|---|---|---|---|
| 4 (000000100) | 26 | 26 | 52 | 26 | 26 | 26 | 26 | 26 | 1 |

| | | | | | | | | |
|---|---|---|---|---|---|---|---|---|
| 5 (000000101) | 26 | 26 | 52 | 26 | 26 | 26 | 52 | 1 |

| | | | | | | | | |
|---|---|---|---|---|---|---|---|---|
| 6 (000000110) | 26 | 26 | 52 | 26 | 52 | 26 | 26 | 1 |

| | | | | | | | |
|---|---|---|---|---|---|---|---|
| 7 (000000111) | 26 | 26 | 52 | 26 | 52 | 52 | 1 |

| | | | | | | | | | |
|---|---|---|---|---|---|---|---|---|---|
| 8 (000001000) | 52 | 26 | 26 | 26 | 26 | 26 | 26 | 26 | 1 |

| | | | | | | | | |
|---|---|---|---|---|---|---|---|---|
| 9 (000001001) | 52 | 26 | 26 | 26 | 26 | 26 | 52 | 1 |

| | | | | | | | | |
|---|---|---|---|---|---|---|---|---|
| 10 (000001010) | 52 | 26 | 26 | 26 | 52 | 26 | 26 | 1 |

| | | | | | | | |
|---|---|---|---|---|---|---|---|
| 11 (000001011) | 52 | 26 | 26 | 26 | 52 | 52 | 1 |

| | | | | | | | | |
|---|---|---|---|---|---|---|---|---|
| 12 (000001100) | 52 | 52 | 26 | 26 | 26 | 26 | 26 | 1 |

| | | | | | | | |
|---|---|---|---|---|---|---|---|
| 13 (000001101) | 52 | 52 | 26 | 26 | 26 | 52 | 1 |

| | | | | | | | |
|---|---|---|---|---|---|---|---|
| 14 (000001110) | 52 | 52 | 26 | 52 | 26 | 26 | 1 |

| | | | | | | |
|---|---|---|---|---|---|---|
| 15 (000001111) | 52 | 52 | 26 | 52 | 52 | 1 |

| | | | | | | | |
|---|---|---|---|---|---|---|---|
| 16 (000010000) | 26 | 26 | 26 | 26 | 26 | 106 | 1 |

| | | | | | | |
|---|---|---|---|---|---|---|
| 17 (000010001) | 26 | 26 | 52 | 26 | 106 | 1 |

| | | | | | | |
|---|---|---|---|---|---|---|
| 18 (000010010) | 52 | 26 | 26 | 26 | 106 | 1 |

| | | | | | |
|---|---|---|---|---|---|
| 19 (000010011) | 52 | 52 | 26 | 106 | 1 |

| | | | | | | | |
|---|---|---|---|---|---|---|---|
| 20 (000010100) | 106 | 26 | 26 | 26 | 26 | 26 | 1 |

| | | | | | | |
|---|---|---|---|---|---|---|
| 21 (000010101) | 106 | 26 | 26 | 26 | 52 | 1 |

| | | | | | | |
|---|---|---|---|---|---|---|
| 22 (000010110) | 106 | 26 | 52 | 26 | 26 | 1 |

| 23 (000010111) | 106 | | 26 | 52 | 52 | 1 |
|---|---|---|---|---|---|---|
| 24 (000011000) | 52 | 52 | — | 52 | 52 | 1 |

| 25 (000011001) | 106 | | | | 26 | 106 | | 1 |
|---|---|---|---|---|---|---|---|---|
| 26 (000011010) | Punctured 242-tone RU | | | | | | | 1 |
| 27 (000011011) | Unassigned 242-tone RU | | | | | | | 1 |
| 28 (000011100) | 242-tone RU; allocated but contributes zero User fields to the User Specific field in | | | | | | | 1 |
| | the same EHT-SIG content channel as this RU Allocation subfield. | | | | | | | |
| 29 (000011101) | 484-tone RU; allocated but contributes zero User fields to the User Specific field in | | | | | | | 1 |
| | the same EHT-SIG content channel as this RU Allocation subfield. | | | | | | | |
| 30 (000011110) | 996-tone RU; allocated but contributes zero User fields to the User Specific field in | | | | | | | 1 |
| | the same EHT-SIG content channel as this RU Allocation subfield. | | | | | | | |
| 31 (000011111) | Validate | | | | | | | 1 |
| 32 (000100000) | 26 | 26 | 26 | 26 | 26 | 52 + 26 | 26 | 1 |

| | | | | | | | |
|---|---|---|---|---|---|---|---|
| 33 (000100001) | 26 | 26 | 52 | 26 | 52 + 26 | 26 | 1 |

| | | | | | | | |
|---|---|---|---|---|---|---|---|
| 34 (000100010) | 52 | 26 | 26 | 26 | 52 + 26 | 26 | 1 |

| | | | | | | |
|---|---|---|---|---|---|---|
| 35 (000100011) | 52 | 52 | 26 | 52 + 26 | 26 | 1 |

| | | | | | | | | |
|---|---|---|---|---|---|---|---|---|
| 36 (000100100) | 26 | 52 + 26 | 26 | 26 | 26 | 26 | 26 | 1 |

| | | | | | | | |
|---|---|---|---|---|---|---|---|
| 37 (000100101) | 26 | 52 + 26 | 26 | 26 | 26 | 52 | 1 |

| | | | | | | | |
|---|---|---|---|---|---|---|---|
| 38 (000100110) | 26 | 52 + 26 | 26 | 52 | 26 | 26 | 1 |

| | | | | | | |
|---|---|---|---|---|---|---|
| 39 (000100111) | 26 | 52 + 26 | 26 | 52 | 52 | 1 |

| | | | | | | |
|---|---|---|---|---|---|---|
| 40 (000101000) | 26 | 26 | 26 | 26 | 106 + 26 | 1 |

| | | | | | |
|---|---|---|---|---|---|
| 41 (000101001) | 26 | 26 | 52 | 106 + 26 | 1 |

| | | | | | |
|---|---|---|---|---|---|
| 42 (000101010) | 52 | 26 | 26 | 106 + 26 | 1 |

| | | | | |
|---|---|---|---|---|
| 43 (000101011) | 52 | 52 | 106 + 26 | 1 |

| | | | | | | |
|---|---|---|---|---|---|---|
| 44 (000101100) | 106 + 26 | 26 | 26 | 26 | 26 | 1 |

| | | | | | |
|---|---|---|---|---|---|
| 45 (000101101) | 106 + 26 | 26 | 26 | 52 | 1 |

| | | | | | |
|---|---|---|---|---|---|
| 46 (000101110) | 106 + 26 | 52 | 26 | 26 | 1 |

| | | | | |
|---|---|---|---|---|
| 47 (000101111) | 106 + 26 | 52 | 52 | 1 |

| 48 (000110000) | 106 + 26 | | | 106 | | 1 |
|---|---|---|---|---|---|---|
| 49 (000110001) | 106 + 26 | | | 52 + 26 | 26 | 1 |
| 50 (000110010) | 106 | | 106 + 26 | | | 1 |
| 51 (000110011) | 26 | 52 + 26 | 106 + 26 | | | 1 |
| 52 (000110100) | 106 | | 26 | 52 + 26 | 26 | 1 |
| 53 (000110101) | 26 | 52 + 26 | 26 | 106 | | 1 |
| 54 (000110110) | 26 | 52 + 26 | 26 | 52 + 26 | 26 | 1 |

| | | | | | |
|---|---|---|---|---|---|
| 55 (000110111) | 52 | 52 + 26 | 52 | 52 | 1 |

| | | |
|---|---|---|
| 56-63 (000111000- | Validate | 8 |
| 000111111) | | |
| 64-71 (001000y₂y₁y₀) | 242 | 8 |
| 72-79 (001001y₂y₁y₀) | 484 | 8 |
| 80-87 (001010y₂y₁y₀) | 996 | 8 |
| 88-95 (001011y₂y₁y₀) | 2 × 996 | 8 |
| 96-103 (001100y₂y₁y₀) | MRU of pattern [gap-242]-242-484, specifically 484 + 242-tone MRU-1, 5, 9, and 13 | 8 |
| | within the first, second, third, and fourth 80 MHz frequency subblock in | |
| | increasing frequency order, respectively | |
| 104-111 (001101y₂y₁y₀) | MRU of pattern 242-[gap-242]-484, specifically 484 + 242-tone MRU-2, 6, 10, and 14 | 8 |
| | within the first, second, third, and fourth 80 MHz frequency subblock in | |
| | increasing frequency order, respectively | |
| 112-119 (001110y₂y₁y₀) | MRU of pattern 484-242-[gap-242]-242 specifically 484 + 242-tone MRU-3, 7, 11, and 15 | 8 |
| | within the first, second, third, and fourth 80 MHz frequency subblock in | |
| | increasing frequency order, respectively | |
| 120-127 (001111y₂y₁y₀) | MRU of pattern 484-242-[gap-242], specifically 484 + 242-tone MRU-4, 8, 12, and 16 | 8 |
| | within the first, second, third, and fourth 80 MHz frequency subblock in | |
| | increasing frequency order, respectively | |
| 128-135 (010000y₂y₁y₀) | MRU of pattern [gap-484]-484-996, specifically 996 + 484-tone MRU-1 and 5 within | 8 |
| | the first and second 160 MHz subblock in increasing frequency order, | |
| | respectively | |
| 136-143 (010001y₂y₁y₀) | MRU of pattern 484-[gap-484]-996, specifically 996 + 484-tone MRU-2 and 6 within | 8 |
| | the first and second 160 MHz subblock in increasing frequency order, | |
| | respectively | |
| 144-151 (010010y₂y₁y₀) | MRU of pattern 996-[gap]-484, specifically 996 + 484-tone MRU-3 and 7 within | 8 |
| | the first and second 160 MHz subblock in increasing frequency order, | |
| | respectively | |
| 152-159 (010011y₂y₁y₀) | MRU of pattern 996-484-[gap-484], specifically 996 + 484-tone MRU-4 and 8 within | 8 |
| | the first and second 160 MHz subblock in increasing frequency order, | |
| | respectively | |
| 160-167 (010100y₂y₁y₀) | MRU of pattern [gap-996]-996-996-996, specifically 3 × 996-tone MRU-1 | 8 |
| 168-175 (010101y₂y₁y₀) | MRU of pattern 996-[gap-996]-996-996, specifically 3 × 996-tone MRU-2 | 8 |
| 176-183 (010110y₂y₁y₀) | MRU of pattern 996-996-[gap-996]-996, specifically 3 × 996-tone MRU-3 | 8 |
| 184-191 (010111y₂y₁y₀) | MRU of pattern 996-996-996-[gap-996], specifically 3 × 996-tone MRU-4 | 8 |
| 192-199 (011000y₂y₁y₀) | MRU of pattern [gap-484]-484-996-996-996, specifically 3 × 996 + 484-tone MRU-1 | 8 |
| 200-207 (011001y₂y₁y₀) | MRU of pattern 484-[gap-484]-996-996-996, specifically 3 × 996 + 484-tone MRU-2 | 8 |
| 208-215 (011010y₂y₁y₀) | MRU of pattern 996-[gap-484]-484-996-996, specifically 3 × 996 + 484-tone MRU-3 | 8 |
| 216-223 (011011y₂y₁y₀) | MRU of pattern 996-484-[gap-484]-996-996, specifically 3 × 996 + 484-tone MRU-4 | 8 |
| 224-231 (011100y₂y₁y₀) | MRU of pattern 996-996-[gap-484]-484-996, specifically 3 × 996 + 484-tone MRU-5 | 8 |
| 232-239 (011101y₂y₁y₀) | MRU of pattern 996-996-484-[gap-484]-996, specifically 3 × 996 + 484-tone MRU-6 | 8 |
| 240-247 (011110y₂y₁y₀) | MRU of pattern 996-996-996-[gap-484]-484, specifically 3 × 996 + 484-tone MRU-7 | 8 |
| 248-255 (011111y₂y₁y₀) | MRU of pattern 996-996-996-484-[gap-484], specifically 3 × 996 + 484-tone MRU-8 | 8 |
| 256-263 (100000y₂y₁y₀) | MRU of pattern [gap-484]-484-996-996, specifically 2 × 996 + 484-tone MRU-1 and 7 | 8 |
| | within the 240 MHz subblock composed of the first, second, and third | |
| | 80 MHz frequency subblock and the 240 MHz subblock composed of the second, | |
| | third, and fourth 80 MHz frequency subblock in increasing frequency order, | |
| | respectively | |
| 264-271 (100001y₂y₁y₀) | MRU of pattern 484-[gap-484]-996-996, specifically 2 × 996 + 484-tone MRU-2 and 8 | 8 |
| | within the 240 MHz subblock composed of the first, second, and third | |
| | 80 MHz freqency subblock and the 240 MHz subblock composed of the second, | |
| | third, and fourth 80 MHz frequency subblock in increasing frequency order, | |
| | respectively | |
| 272-279 (100010y₂y₁y₀) | MRU of pattern 996-[gap-484]-484-996, specifically 2 × 996 + 484-tone MRU-3 and 9 | 8 |
| | within the 240 MHz subblock composed of the first, second, and third | |
| | 80 MHz frequency subblock and the 240 MHz subblock composed of the second, | |
| | third, and fourth 80 MHz frequency subblock in increasing frequency order, | |
| | respectively | |
| 280-287 (100011y₂y₁y₀) | MRU of pattern 996-484-[gap-484]-996, specifically 2 × 996 + 484-tone MRU-4 and 10 | 8 |
| | within the 240 MHz subblock composed of the first, second, and third | |
| | 80 MHz frequency subblock and the 240 MHz subblock composed of the second, | |
| | third, and fourth 80 MHz frequency subblock in increasing frequency order, | |
| | respectively | |
| 288-295 (100100y₂y₁y₀) | MRU of pattern 996-996-[gap-484]-484, specifically 2 × 996 + 484-tone MRU-5 and 11 | 8 |
| | within the 240 MHz subblock composed of the first, second, and third | |
| | 80 MHz frequency subblock and the 240 MHz subblock composed of the second, | |
| | third, and fourth 80 MHz frequency subblock in increasing frequency order, | |
| | respectively | |
| 296-303 (100101y₂y₁y₀) | MRU of pattern 996-996-484-[gap-484], specifically 2 × 996 + 484-tone MRU-6 and 12 | 8 |
| | within the 240 MHz subblock composed of the first, second, and third | |
| | 80 MHz frequency subblock and the 240 MHz subblock composed of the second, | |
| | third, and fourth 80 MHz frequency subblock in increasing frequency order, | |
| | respectively | |
| 304-511 (100110y₂y₁y₀)- | Disregard | 26 × 8 |
| 111111y₂y₁y₀) | | |

For an RU Allocation subfield with value greater than or equal to 64, y₂y₁y₀ = 000-111 indicates the number of User fields in the EHT-SIG content channel that contains the corresponding 9-bit RU Allocation subfield.
The binary vector y₂y₁y₀ indicates Nᵤₛₑᵣ(r, c) = 2² × y₂ + 2¹ × y₀ + 1 User fields in the EHT-SIG content channel that contains the corresponding 9-bit RU Allocation subfield.
[Gap-242/484/996] indicates a 242/484/996-tone that is not overlapped with the RU or MRU indicated by the 9-bit RU Allocation subfield and is to help indicate the frequency order of the MRU within an 80/160/240/320 MHz subblock.

The RU or MRU associated with each RU Allocation subfield for each EHT-SIG content channel and PPDU bandwidth is defined as follows:

TABLE 6

| | | RUs or MRUs in the |
|---|---|---|
| | | subcarrier range, or |
| | | overlapping with the |
| | | subcarrier range if the |
| PPDU | | RU or MRU is larger |
| bandwidth | RU Allocation subfield | than a 242-tone RU |
| 20 MHz | The RU Allocation subfield in a single EHT-SIG content channel | [−122: 122] |
| 40 MHz | The RU Allocation subfield in EHT-SIG content channel 1 | [−244: −3] |
| | The RU Allocation subfield in EHT-SIG content channel 2 | [3: 244] |
| 80 MHz | The first RU Allocation subfield in EHT-SIG content channel 1 | [−500: −259] |
| | The first RU Allocation subfield in EHT-SIG content channel 2 | [−253: −12] |
| | The second RU Allocation subfield in EHT-SIG content channel 1 | [12: 253] |
| | The second RU Allocation subfield in EHT-SIG content channel 2 | [259: 500] |
| 160 MHz | The first RU Allocation subfield in EHT-SIG content channel 1 | [−1012: −771] |
| | The first RU Allocation subfield in EHT-SIG content channel 2 | [−765: −524] |
| | The second RU Allocation subfield in EHT-SIG content channel 1 | [−500: −259] |
| | The second RU Allocation subfield in EHT-SIG content channel 2 | [−253: −12] |
| | The third RU Allocation subfield in EHT-SIG content channel 1 | [12: 253] |
| | The third RU Allocation subfield in EHT-SIG content channel 2 | [259: 500] |
| | The fourth RU Allocation subfield in EHT-SIG content channel 1 | [524: 765] |
| | The fourth RU Allocation subfield in EHT-SIG content channel 2 | [771: 1012] |
| 320 MHz | The first RU Allocation subfield in EHT-SIG content channel 1 | [−2036: −1795] |
| | The first RU Allocation subfield in EHT-SIG content channel 2 | [−1789: −1548] |
| | The second RU Allocation subfield in EHT-SIG content channel 1 | [−1524: −1283] |
| | The second RU Allocation subfield in EHT-SIG content channel 2 | [−1277: −1036] |
| | The third RU Allocation subfield in EHT-SIG content channel 1 | [−1012: −771] |
| | The third RU Allocation subfield in EHT-SIG content channel 2 | [−765: −524] |
| | The fourth RU Allocation subfield in EHT-SIG content channel 1 | [−500: −259] |
| | The fourth RU Allocation subfield in EHT-SIG content channel 2 | [−253: −12] |
| | The fifth RU Allocation subfield in EHT-SIG content channel 1 | [12: 253] |
| | The fifth RU Allocation subfield in EHT-SIG content channel 2 | [259: 500] |
| | The sixth RU Allocation subfield in EHT-SIG content channel 1 | [524: 765] |
| | The sixth RU Allocation subfield in EHT-SIG content channel 2 | [771: 1012] |
| | The seventh RU Allocation subfield in EHT-SIG content channel 1 | [1036: 1277] |
| | The seventh RU Allocation subfield in EHT-SIG content channel 2 | [1283: 1524] |
| | The eighth RU Allocation subfield in EHT-SIG content channel 1 | [1548: 1789] |
| | The eighth RU Allocation subfield in EHT-SIG content channel 2 | [1795: 2036] |

The User Specific field of the EHT-SIG content channel consists of zero or more user encoding blocks. The User Specific field does not exist for EHT sounding NDP.

For DL GEDMA transmission (UL/DL fields in the U-SIG field are set to 0 and PPDU Type And Compression Mode field is set to 0), the number of user fields is indicated by the RU Allocation subfield. Each user encoding block other than the last one consists of two user fields containing information about the two STAs used to decode the payload. The last user encoding block contains information about one or two users, depending on the number of user fields in the EHT-SIG content channel.

The Common field of the EHT-SIG content channel is encoded together with the first User field of the same content channel. This common encoding block contains the CRC and Tail. The contents of the common encoding block of the EHT-SIG field for EHT SU transmission to multiple users and non-GEDMA transmission are defined in Table 7 (EHT SU transmission and non-OFDMA transmission to multiple users). For non-OFDMA transmission to multiple users, the remaining user fields (if any) of each content channel are grouped into user encoding blocks using the same method as for OFDMA transmission.

TABLE 7

| | | Number of bits | |
|---|---|---|---|
| Bit | Subfield | per subfield | Description |
| B0-B19 | Common field for an EHT SU | 20 | The Common field for an EHT SU |
| | transmission and non-OFDMA | | transmission and non-OFDMA transmission |
| | transmission to multiple users | | to multiple users is defined in Common |
| | | | field for an EHT SU transmission and non- |
| | | | OFDMA transmission to multiple users. |
| B20-B41 | User field | 22 | The User field format for a non-MU-MIMO |
| | | | allocation is defined in Table 9 (User field |
| | | | format for a non-MU-MIMO allocation). |
| | | | The User field format for an MU-MIMO |
| | | | allocation is defined in Table 10 (User field |
| | | | format for an MU-MIMO allocation). |
| B42-B45 | CRC | 4 | The CRC is calculated over bits 0 to 41. The |
| | | | CRC computation uses the same polynomial |
| | | | as that in CRC computation. |
| B46-B51 | Tail | 6 | Used to terminate the trellis of the |
| | | | convolutional decoder. Set to 0. |

The user encoding block is defined as in Table 8. For non-OFDMA transmissions to multiple users, a user encoding block exists when there is at least one User field in the corresponding content channel.

TABLE 8

| | | Number of | Number of bits | |
|---|---|---|---|---|
| Bit | Subfield | subfields | per subfield | Description |
| B0- | User field | N | 22 | N User fields are present, where: |
| B22N − 1 | | | | N = 1 if it is the final user encoding block, |
| | | | | and if there is only one user in the final user |
| | | | | encoding block. |
| | | | | N = 2 otherwise. |
| | | | | The User field format for a non-MU-MIMO |
| | | | | allocation is defined in Table 9 (User field |
| | | | | format for a non-MU-MIMO allocation). The |
| | | | | User field format for an MU-MIMO |
| | | | | allocation is defined in Table 10 (User field |
| | | | | format for an MU-MIMO allocation). |
| B22N- | CRC | 1 | 4 | The CRC is calculated over bits 0 to 21 for a |
| B22N + 3 | | | | user encoding block that contains one User |
| | | | | field, and bits 0 to 43 for a user encoding block |
| | | | | that contains two User fields. The CRC |
| | | | | computation uses the same polynomial as that |
| | | | | in CRC computation. |
| B22N + 4- | Tail | 1 | 6 | Used to terminate the trellis of the |
| B22N + 9 | | | | convolutional decoder. Set to 0. |

The content of the User field depends on whether the field addresses a user in a non-MU-MIMO allocation in the RU or a user in a MU-MIMO allocation in the RU. For EHT SU transmissions, the User field format for non-MU-MIMO allocations is used.

The User field format for non-MU-MIMO allocations is defined in Table 9.

TABLE 9

| | | Number | |
|---|---|---|---|
| Bit | Subfield | of bits | Description |
| B0-B10 | STA-ID | 11 | Set to a value of the TXVECTOR parameter STA- |
| | | | ID. |
| B11-B14 | MCS | 4 | If the STA-ID subfield is not equal to 2046, this |
| | | | subfield indicates the following modulation and coding |
| | | | scheme: |
| | | | Set to n for EHT-MCS n, where n = 0, 1, . . . , 15. |
| | | | Set to an arbitrary value if the STA-ID subfield is equal |
| | | | to 2046. |
| | | | If the UL/DL subfield of the U-SIG field is set to 0: |
| | | | If the value of STA-ID subfield matches the |
| | | | user's STA-ID, the value of EHT-MCS 14 or |
| | | | EHT-MCS 15 is Validate if the condition |
| | | | described in Introduction to the EHT PHY |
| | | | is not met. |
| | | | If the value of STA-ID subfield does not |
| | | | match the user's STA-ID, all values are |
| | | | Disregard. |
| | | | If the UL/DL subfield of the U-SIG field is set to 1, the |
| | | | value of EHT-MCS 14 or EHT-MCS 15 is Validate if |
| | | | the condition described in Introduction to the EHT |
| | | | PHY is not met. |
| B15 | Reserved | 1 | Reserved and set to 1. |
| | | | If the UL/DL subfield of the U-SIG field is set to 0: |
| | | | If the value of STA-ID subfield matches the |
| | | | user's STA-ID, the Reserved subfield is |
| | | | Validate. |
| | | | If the value of STA-ID subfield does not |
| | | | match the user's STA-ID, the Reserved |
| | | | subfield is Disregard. |
| | | | If the UL/DL subfield of the U-SIG field is set to 1, the |
| | | | Reserved subfield is Validate. |
| B16-B19 | NSS | 4 | If the STA-ID subfield is not equal to 2046, it indicates |
| | | | the number of spatial streams for up to eight spatial |
| | | | streams. |
| | | | Set to the number of spatial streams minus 1. |
| | | | Set to an arbitrary value if the STA-ID subfield is equal |
| | | | to 2046. |
| | | | If the UL/DL subfield of the U-SIG field is set to 0: |
| | | | If the value of STA-ID subfield matches the |
| | | | user's STA-ID, values indicating more than |
| | | | eight spatial streams are Validate. |
| | | | If the value of STA-ID subfield does not |
| | | | match the user's STA-ID, all values are |
| | | | Disregard. |
| | | | If the UL/DL subfield of the U-SIG field is set to 1, |
| | | | values indicating more than eight spatial streams are |
| | | | Validate. |
| B20 | Beamformed | 1 | If the STA-ID subfield is not 2046, this subfield is used |
| | | | to indicate transmit beamforming: |
| | | | Set to 1 if a beamforming steering matrix is applied to |
| | | | the waveform in a non-MU-MIMO allocation. |
| | | | Set to 0 otherwise. |
| | | | Set to an arbitrary value if the STA-ID subfield is |
| | | | 2046. |
| B21 | Coding | 1 | If the STA-ID subfield is not equal to 2046, this |
| | | | subfield indicates whether BCC or LDPC is used: |
| | | | Set to 0 for BCC. |
| | | | Set to 1 for LDPC. |
| | | | Set to an arbitrary value if the STA-ID subfield is |
| | | | 2046. |
| | | | If the UL/DL subfield of the U-SIG field is set to 0 and |
| | | | if the value of STA-ID subfield does not match the |
| | | | user's STA-ID, all values are Disregard. |

The User field format for MU-MIMO allocation is defined in Table 10.

TABLE 10

| | | Number | |
|---|---|---|---|
| Bit | Subfield | of bits | Description |
| B0-B10 | STA-ID | 11 | Set to a value of the TXVECTOR parameter STA- |
| | | | ID. |
| B11-BI4 | MCS | 4 | If the STA-ID subfield is not equal to 2046, this |
| | | | subfield indicates the following modulation and coding |
| | | | scheme: |
| | | | Set to n for EHT-MCS n, where n = 0, 1, . . . , 13. |
| | | | Set to an arbitrary value if the STA-ID subfield is equal |
| | | | to 2046. |
| | | | If the value of STA-ID subfield matches the user's |
| | | | STA-ID, other values are Validate. If the value of |
| | | | STA-ID subfield does not match the user's STA-ID, all |
| | | | values are Disregard. |
| B15 | Coding | 1 | If the STA-ID subfield is not equal to 2046, this |
| | | | subfield indicates whether BCC or LDPC is used: |
| | | | Set to 0 for BCC. |
| | | | Set to 1 for LDPC. |
| | | | If the RU size is larger than 242, this bit is reserved and |
| | | | set to 1. |
| | | | Set to an arbitrary value if the STA-ID subfield is equal |
| | | | to 2046. |
| | | | If the value of STA-ID subfield matches the user's |
| | | | STA-ID, the Reserved subfield is Validate. If the value |
| | | | of STA-ID subfield does not match the user's STA-ID, |
| | | | the Reserved subfield is Disregard. |
| B16-B21 | Spatial Configuration | 6 | Indicates the number of spatial streams for a user in an |
| | | | MU-MIMO allocation: |
| | | | If STA-ID matches, the values that are reserved or |
| | | | do not exist in Spatial Configuration subfield |
| | | | encoding are Validate. |
| | | | If STA-ID does not match, all values are Disregard. |

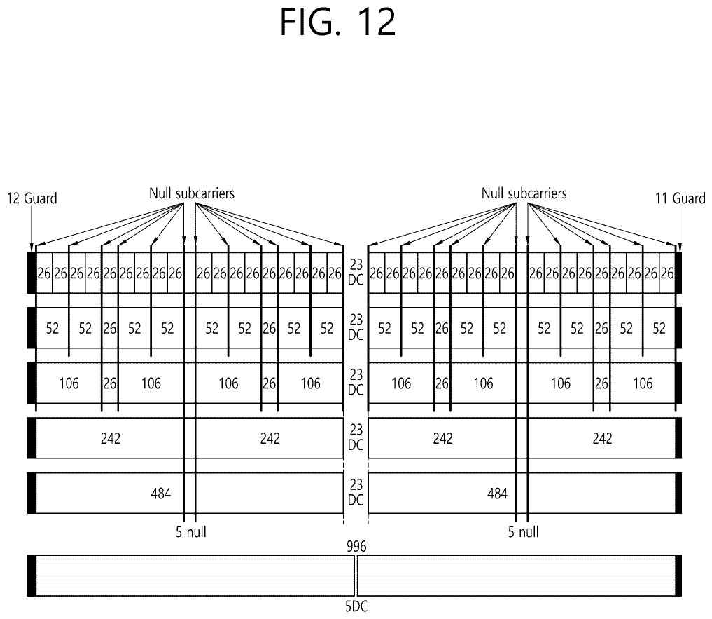

FIG. 12 is the 80 MHz tone plan defined in 802.11be.

The EHT tone plan and RU positions for an 80 MHz PPDU are illustrated in FIG. 12. An EHT PPDU of 160 MHz or more consists of multiple 80 MHz frequency subblocks. The tone plan and RU allocation for each 80 MHz frequency subblock are the same as the 80 MHz EHT PPDU. If an 80 MHz frequency subblock of a 160 MHz or 320 MHz EHT PPDU is not punctured and the entire 80 MHz frequency subblock is used as an RU or is a part of an RU or an MRU, the 80 MHz frequency subblock uses 996-tone RUs as illustrated in FIG. 12. If the 80 MHz frequency subblock includes RUs smaller than 996 tones or a part of the 80 MHz frequency subblock is punctured, the 80 MHz frequency subblock uses the tone plan and RU allocation as illustrated in FIG. 12 except for the 996-tone RU.

### 2. Definition of the User Info Field in the Trigger Frame

A trigger frame other than the Multi User-Request to Send (MU-RTS) trigger frame allocates and requests resources for the transmission of one or more HE Trigger Based (TB) PPDUs. An MU-RTS trigger frame allocates resources for one or more PPDUs other than TB PPDUs.

The trigger frame also carries other information required for the responding STA to transmit a HE TB PPDU, EHT TB PPDU, non-HT PPDU or non-HT duplicate PPDU, HE Ranging NDP or HE TB Ranging NDP in response to that trigger frame.

A trigger frame contains a Common Info field and a User Info field, and the User Info field has three variants: a Special User Info field, a HE variant User Info field, and an EHT variant User Info field.

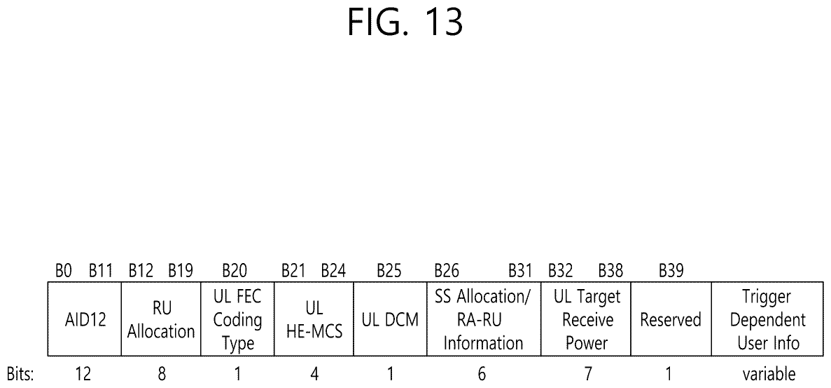

FIG. 13 shows the format of the HE variant User Info field of the trigger frame.

Referring to FIG. 13, the HE variant User Info field includes an RU Allocation subfield.

The RU Allocation subfield of the HE variant User Info field, together with the UL BW subfield of the Common Info field, identifies the size and location of the RU. If the UL BW subfield indicates a 20 MHz, 40 MHz or 80 MHz PPDU, B0 of the RU Allocation subfield is set to 0. If the UL BW subfield indicates 80+80 MHz or 160 MHz, B0 of the RU Allocation subfield is set to 0 to indicate that the RU allocation applies to the primary 80 MHz channel, or to 1 to indicate that the RU allocation applies to the secondary 80 MHz channel. The B7-B1 mapping of the RU Allocation subfield for a trigger frame other than an MU-RTS trigger frame is defined in Table 11.

TABLE 11

| B7-B1 of the | | | |
|---|---|---|---|
| RU Allocation | | | |
| subfield | UL BW subfield | RU size | RU Index |
| 0-8 | 20 MHz, 40 MHz, 80 MHz, | 26 | RU1 to RU9, respectively |
| | 80 + 80 MHz or 160 MHz | | |
| 9-17 | 40 MHz, 80 MHz, 80 + 80 MHz | | RU10 to RU18, respectively |
| | or 160 MHz | | |
| 18-36 | 80 MHz, 80 + 80 MHz or | | RU19 to RU37, respectively |
| | 160 MHz | | |
| 37-40 | 20 MHz, 40 MHz, 80 MHz, | 52 | RU1 to RU4, respectively |
| | 80 + 80 MHz or 160 MHz | | |
| 41-44 | 40 MHz, 80 MHz, 80 + 80 MHz | | RU5 to RU8, respectively |
| | or 160 MHz | | |
| 45-52 | 80 MHz, 80 + 80 MHz or | | RU9 to RU16, respectively |
| | 160 MHz | | |
| 53, 54 | 20 MHz, 40 MHz, 80 MHz | 106 | RU1 and RU2, respectively |
| | 80 + 80 MHz or 160 MHz | | |
| 55, 56 | 40 MHz, 80 MHz, 80 + 80 MHz | | RU3 and RU4, respectively |
| | or 160 MHz | | |
| 57-60 | 80 MHz, 80 + 80 MHz or | | RU5 to RU8, respectively |
| | 160 MHz | | |
| 61 | 20 MHz, 40 MHz, 80 MHz, | 242 | RU1 |
| | 80 + 80 MHz or 160 MHz | | |
| 62 | 40 MHz, 80 MHz, 80 + 80 MHz | | RU2 |
| | or 160 MHz | | |
| 63, 64 | 80 MHz, 80 + 80 MHz or | | RU3 and RU4, respectively |
| | 160 MHz | | |
| 65 | 40 MHz, 80 MHz, 80 + 80 MHz | 484 | RU1 |
| | or 160 MHz | | |
| 66 | 80 MHz, 80 + 80 MHz or | | RU2 |
| | 160 MHz | | |
| 67 | 80 MHz, 80 + 80 MHz or | 996 | RU1 |
| | 160 MHz | | |
| 68 | 80 + 80 MHz or 160 MHz | 2 × 996 | RU1 |

NOTE-
If the UL BW subfield indicates 80 + 80 MHz or 160 MHz, the description indicates the RU index for the primary 80 MHz channel or secondary 80 MHz channel as indicated by B0 of the RU Allocation subfield.

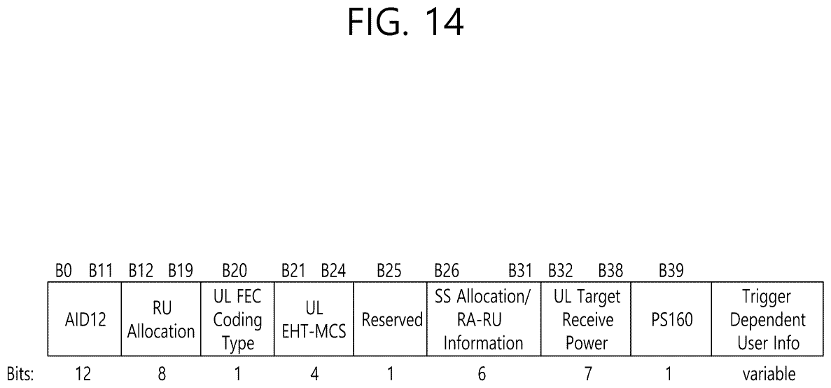

FIG. 14 shows the format of the EHT variant User Info field of the trigger frame.

Referring to FIG. 14, the EHT variant User Info field includes a RU Allocation subfield.

The RU Allocation subfield of the EHT variant User Info field and the PS160 subfield of the EHT variant User Info field of a non-MU-RTS trigger frame together with the UL BW subfield of the Common Info field, the UL BW Extension subfield of the Special User Info field identify the size and the location of an RU or MRU. The B7-B1 mapping of the RU Allocation subfield together with the B0 setting of the PS160 subfield of the EHT variant User Info field and the RU Allocation subfield is defined in Table 12. Here, the bandwidth is obtained from the combination of the UL BW subfield and the UL Bandwidth Extension subfield, and N is obtained from Table 13 (lookup table for X1 and N) derived from Equation 1.

TABLE 12

| | B0 of | B7-B1 of | | | | |
|---|---|---|---|---|---|---|
| | the RU | the RU | | | | PHY RU or |
| PS160 | Allocation | Allocation | Bandwidth | RU or MRU | RU or | MRU |
| subfield | subfield | subfield | (MHz) | size | MRU index | index |
| 0-3: | | 0-8 | 20, 40, 80, | 26 | RU1 to RU9, | 37 × N + RU |
| 80 MHz frequency subblock | | | 160, or 320 | | respectively | index |
| where the RU is located | | 9-17 | 40, 80, 160, | | RU10 to RU18, | |
| (See NOTE 1) | | | or 320 | | respectively | |
| | | 18 | 80, 160, or | | Reserved | |
| | | | 320 | | | |
| | | 19-36 | 80, 160, or | | RU20 to RU37 | |
| | | | 320 | | respectively | |
| | | 37-40 | 20, 40, 80, | 52 | RU1 to RU4, | 16 × N + RU |
| | | | 160, or 320 | | respectively | index |
| | | 41-44 | 40, 80, 160, | | RU5 to RU8, | |
| | | | or 320 | | respectively | |
| | | 45-52 | 80, 160, or | | RU9 to RU16, | |
| | | | 320 | | respectively | |
| | | 53, 54 | 20, 40, 80, | 106 | RU1 and RU2, | 8 × N + RU |
| | | | 160, or 320 | | respectively | index |
| | | 55, 56 | 40, 80, 160, | | RU3 and RU4, | |
| | | | or 320 | | respectively | |
| | | 57-60 | 80, 160, or | | RU5 to RU8, | |
| | | | 320 | | respectively | |
| | | 61 | 20, 40, 80, | 242 | RU1 | 4 × N + RU |
| | | | 160, or 320 | | | index |
| | | 62 | 40, 80, 160, | | RU2 | |
| | | | or 320 | | | |
| | | 63, 64 | 80, 160, or | | RU3 and RU4, | |
| | | | 320 | | respectively | |
| | | 65 | 40, 80, 160, | 484 | RU1 | 2 × N + RU |
| | | | or 320 | | | index |
| | | 66 | 80, 160, or | | RU2 | |
| | | | 320 | | | |
| | | 67 | 80, 160, or | 996 | RU1 | N + RU |
| | | | 320 | | | index |
| 0-1: | 0 | 68 | 20, 40, 80, | Reserved | Reserved | Reserved |
| 160 MHz | | | 160, or | | | |
| segment | | | 320 | | | |
| where the | 1 | | 160 or 320 | 2 × 996 | RU1 | X1 + RU |
| RU is | | | | | | index |
| located (See | | | | | | |
| NOTE 3) | | | | | | |
| 0 | 0 | 69 | 20, 40, 80, | Reserved | Reserved | Reserved |
| 0 | 1 | | 160, or | | | |
| 1 | 0 | | 320 | | | |
| 1 | 1 | | 320 | 4 × 996 | RU1 | RU1 |
| 0-3: | | 70 | 20, 40 | 52 + 26 | MRU1 | 12 × N + |
| 80 MHz frequencey | | | 80, 160, or | Reserved | Reserved | MRU index |
| subblock where the | | | 320 | | | |
| MRU is located | | 71-72 | 20, 40, 80, | 52 + 26 | MRU2 and MRU3, | |
| (See NOTE 1) | | | 160, or 320 | | respectively | |
| | | 73-74 | 40, 80, 160, | 52 + 26 | MRU4 and MRU5, | |
| | | | or 320 | | respectively | |
| | | 75 | 40 | 52 + 26 | MRU6 | |
| | | | 80, 160, or | Reserved | Reserved | |
| | | | 320 | | | |
| | | 76 | 20, 40, 80, | Reserved | Reserved | |
| | | | 160, or | | | |
| | | | 320 | | | |
| | | 77-80 | 80, 160, or | 52 + 26 | MRU8 to MRU11, | |
| | | | 320 | | respectively | |
| | | 81 | 20, 40, 80, | Reserved | Reserved | |
| | | | 160, or | | | |
| | | | 320 | | | |
| | | 82 | 20, 40, 80, | 106 + 26 | MRU1 | 8 × N + |
| | | | 160, or 320 | | | MRU index |
| | | 83 | 20,40 | 106 + 26 | MRU2 | |
| | | | 80, 160, or | Reserved | Reserved | |
| | | | 320 | | | |
| | | 84 | 40 | 106 + 26 | MRU3 | |
| | | | 80, 160, or | Reserved | Reserved | |
| | | | 320 | | | |
| | | 85 | 40,80, 160, | 106 + 26 | MRU4 | |
| | | | or 320 | | | |
| | | 86 | 80, 160, or | 106 + 26 | MRU5 | |
| | | | 320 | | | |
| | | 87-88 | 20, 40, 80, | Reserved | Reserved | |
| | | | 160, or | | | |
| | | | 320 | | | |
| | | 89 | 80, 160, or | 106 + 26 | MRU8 | |
| | | | 320 | | | |
| | | 90-93 | 80, 160, or | 484 + 242 | MRU1 to MRU4, | 4 × N + |
| | | | 320 | | respectively | MRU index |
| 0-1: | 0 | 94, 95 | 160 or 320 | 996 + 484 | MRU1 and MRU2, | 4 × X1 + |
| 160 MHz | | | | | respectively | MRU index |
| segment | 1 | | | | MRU3 and MRU4, | |
| where the | | | | | respectively | |
| MRU is | | | | | | |
| located (See | | | | | | |
| NOTE 3) | | | | | | |
| 0: MRU is | 0 | 96-99 | 160 | 996 + 484 + | MRU1 to MRU4, | MRU |
| located in the | | | | 242 | respectively | index |
| primary | 1 | | | | MRU5 to MRU8, | |
| 160 MHz | | | | | respectively | |
| 1 | Any | | 20, 40, 80, | Reserved | Reserved | Reserved |
| | | | 160, or | | | |
| | | | 320 | | | |
| 0 | 0 | 100-103 | 320 | 2 × 996 + | MRU1 to MRU4, | MRU index |
| | | | | 484 | respectively | |
| 0 | 1 | 100-101 | | | MRU5 and MRU6, | |
| | | | | | respectively | |
| 0 | 1 | 102-103 | 20, 40, 80, | Reserved | Reserved | |
| | | | 160, or | | | |
| | | | 320 | | | |
| 1 | 0 | 100-101 | 20, 40, 80, | Reserved | Reserved | |
| | | | 160, or | | | |
| | | | 320 | | | |
| 1 | 0 | 102-103 | 320 | 2 × 996 + | MRU7 and MRU8, | |
| | | | | 484 | respectively | |
| 1 | 1 | 100-103 | | | MRU9 to MRU12, | |
| | | | | | respectively | |
| 0 | 0 | 104 | 320 | 3 × 996 | MRU1 | MRU index |
| 0 | 1 | | | | MRU2 | |
| 1 | 0 | | | | MRU3 | |
| 1 | 1 | | | | MRU4 | |
| 0 | 0 | 105, 106 | 320 | 3 × 996 + | MRU1 and MRU2, | MRU index |
| | | | | 484 | respectively | |
| 0 | 1 | | | | MRU3 and MRU4, | |
| | | | | | respectively | |
| 1 | 0 | | | | MRU5 and MRU6, | |
| | | | | | respectively | |
| 1 | 1 | | | | MRU7 and MRU8, | |
| | | | | | respectively | |
| Any | Any | 107-127 | 20, 40, 80, | Reserved | Reserved | Reserved |
| | | | 160, or | | | |
| | | | 320 | | | |

(NOTE 1)-
B0 of the RU Allocation subfield is set to 0 to indicate that the RU or MRU allocation applies to the primary 80 MHz channel and set to 1 to indicate that the RU allocation applies to the secondary 80 MHz channel in the primary 160 MHz, if PS160 subfield is equal to 0 and RU or MRU size is smaller than or equal to 996 tones. B0 of the RU Allocation subfield is set to 0 to indicate that the RU or MRU allocation applies to the lower 80 MHz in the secondary 160 MHz and is set to 1 to indicate that the RU or MRU allocation applies to upper 80 MHz in the secondary 160 MHz, if PS160 subfield is equal to 1 and the RU or MRU size is smaller than or equal to 996 tones.
(NOTE 2)-
The PHY MRU index of a 52 + 26-tone MRU is not defined in the case of the MRU index equal to 1, 6, 7, or 12, if the bandwidth indicates 80, 160, or 320 MHz. The PHY MRU index of a 106 + 26-tone MRU is not defined in the case of the MRU index equal to 2, 3, 6, or 7, if the bandwidth indicates 80, 160, or 320 MHz.
(NOTE 3)-
If the size of RU or MRU is smaller than or equal to 2 × 996 tone, then the PS160 subfield is set to 0 to indicate the RU or MRU allocation applies to the primary 160 MHz channel and set to 1 to indicate the RU or MRU allocation applies to the secondary 160 MHz channel. Otherwise, the PS160 subfield is used to indicate the RU or MRU index along with the RU Allocation subfield.
(NOTE 4)-
The PHY RU or MRU index in this table indicates the allocated RU or MRU index defined in Subcarrier and resource allocation.

The parameter N in the trigger frame RU Allocation table is calculated by the following mathematical formula:

$$N = 2 \times X 1 + X 0 \qquad [ Equation 1 ]$$

Table 13 (Lookup table for X1 and N) summarizes how to calculate N for various configurations using the equation 1.

TABLE 13

| Bandwidth | Inputs | | | Outputs | | |
|---|---|---|---|---|---|---|
| (MHz) | Configuration | PS160 | B0 | X0 | X1 | N |
| 20/40/80 | [P80] | 0 | 0 | 0 | 0 | 0 |
| 160 | [P80 S80] | 0 | 0 | 0 | 0 | 0 |
| | | 0 | 1 | 1 | 0 | 1 |
| | [S80 P80] | 0 | 0 | 1 | 0 | 1 |
| | | 0 | 1 | 0 | 0 | 0 |
| 320 | [P80 S80 S160] | 0 | 0 | 0 | 0 | 0 |
| | | 0 | 1 | 1 | 0 | 1 |
| | | 1 | 0 | 0 | 1 | 2 |
| | | 1 | 1 | 1 | 1 | 3 |
| | [S80 P80 S160] | 0 | 0 | 1 | 0 | 1 |
| | | 0 | 1 | 0 | 0 | 0 |
| | | 1 | 0 | 0 | 1 | 2 |
| | | 1 | 1 | 1 | 1 | 3 |
| | [S160 P80 S80] | 0 | 0 | 0 | 1 | 2 |
| | | 0 | 1 | 1 | 1 | 3 |
| | | 1 | 0 | 0 | 0 | 0 |
| | | 1 | 1 | 1 | 0 | 1 |
| | [S160 S80 P80] | 0 | 0 | 1 | 1 | 3 |
| | | 0 | 1 | 0 | 1 | 2 |
| | | 1 | 0 | 0 | 0 | 0 |
| | | 1 | 1 | 1 | 0 | 1 |

### 3. Embodiments Applicable to this Specification

In order to improve latency in a wireless LAN system (802.11), a case may be considered in which multiple PSDUs (PLCP (Physical Layer Convergence Procedure) Service Data Units) are transmitted to a single STA, or a single STA transmits multiple PSDUs. This embodiment proposes a method of allocating RU/MRU to a corresponding STA in MU PPDU or TB PPDU, considering a single link operation situation.

This specification considers a situation where multiple PSDUs need to be transmitted to a specific STA or by a specific STA, considering urgent data or data that must guarantee low latency. When transmitting multiple PSDUs, the simplest method is to use a method of transmitting different PSDUs on different links using multi-link operation, but not all links can always be idle at the same time. However, if an STA can only operate on a single link (a multi-link capable device or a device that can only operate on a single link when transmitting and receiving, or a single link only capable device), a situation where multiple PSDUs are transmitted on a single link can be considered. That is, each PSDU can be allocated to multiple RUs or MRUs within a single link, and the following method of allocating RUs/MRUs is proposed, considering desirable operation and complexity. This method can be applied to RU/MRU allocation of MU PPDU or TB PPDU.

1) Allocation Only within the Channel within the STA Operating Bandwidth

Considering the bandwidth in which the STA operates, one RU or MRU can be allocated for each PSDU only within the channel in which the STA operates among the channels within a specific PPDU bandwidth.

2) Allocation of the Same RU/MRU with Other STAs May not be Possible

When transmitting multiple PSDUs to one STA or when one STA transmits, the RU/MRU allocated for each PSDU transmission may not be allocated for data transmission of other STAs. That is, MU-MIMO transmission may not be considered in the corresponding RU/MRU. This is to facilitate encoding or decoding of one STA transmitting or receiving multiple PSDUs.

3) Allocation of Adjacent RU/MRU or Other RU/MRU Between the RU/MRU to which the STA is Assigned May not be Assigned to Another STA

When multiple PSDUs are transmitted to one STA or transmitted by one STA, the RU/MRUs allocated for each PSDU transmission may be consecutive. If they are non-contiguous, no STA may be assigned to another RU/MRU between the RUs/MRUs. For example, when allocating an STA to RUs located on both sides of middle 26 RU, no other STA may be assigned to middle 26 RU.

Through this proposal, the User field for the corresponding STA can be positioned continuously within each content channel in the case of MU PPDU, and thus, the decoding of the STA's EHT-SIG (or Next version SIG) can be facilitated, and the power saving effect can also be obtained.

In addition, when the corresponding STA receives MU PPDU, it can be easily operated in performing AGC of STF and channel estimation of LTF, and data decoding implementation can also be facilitated.

In addition, the STA may be able to easily configure the preamble when transmitting TB PPDU, and there may be implementation benefits when encoding data.

### 4) The Modulation and Coding Scheme (MCS), Number of Streams, Coding, and Beamforming May be the Same in Different Allocated RUs/MRUs.

Although the MCS, number of streams, coding method, beamforming, etc. may be applied differently depending on the size and channel status of the PSDU in each RU/MRU to which different PSDUs are allocated, they can all be applied equally to reduce the complexity when transmitting or receiving the corresponding STA. However, by appropriately allocating the RU/MRU size depending on the PSDU size and channel status, problems such as increased overhead and decreased throughput can be compensated for. When applying this proposal, except for one User field among the User Info fields of the User field of the EHT-SIG (or Next version SIG) in which the information of the corresponding STA is carried (which may be the first User field among the User fields for the corresponding STA), subfields for the corresponding information (such as MCS, number of streams, coding, and beamforming that are applied equally) may be reserved or used for other purposes. In addition, except for one User Info field (which may be the first User Info field among the User Info fields for the STA) among the User Info fields of the Trigger frame (the EHT Trigger frame may be used as is or the enhanced Trigger frame may be used in the next version) in which the information of the corresponding STA is carried, subfields for the corresponding information (such as MCS, number of streams, coding and beamforming that are applied equally, etc.) may be reserved or may be used for other purposes.

If used for other purposes, the User field/User Info field can indicate information about whether it is the last User field/User Info field for the STA. In addition, the User field/User Info field can also indicate the number of User fields/User Info fields for the STA (i.e., the number of allocated RUs/MRUs or the number of PSDUs), the number of remaining User fields/User Info fields for the STA, etc. In addition, the reserved B15 of the User field (see Table 9) for non-MU-MIMO allocation of EHT-SIG (or Next version SIG) can be used to indicate information about whether the User field/User Info field is the last User field/User Info field.

The subfields used for other purposes as described above may exist in all or only some of the User fields/User Info fields except for one User field/User Info field among the User fields/User Info fields in which the information of the STA is carried.

As above, when multiple PSDUs are transmitted to one STA or one STA transmits (each of which is MU PPDU and TB PPDU), the existing defined RU/MRU allocation indication method can be utilized as is. However, the difference from the existing one is that in the case of MU PPDU, there can be multiple User fields for the corresponding STA in EHT-SIG (or Next version SIG), and in the case of TB PPDU, there can be multiple User Info fields for the corresponding STA in Trigger frame (EHT Trigger frame can be used as is or an enhanced Trigger frame can be used in the next version) (it may be desirable to exist consecutively). In each situation, the number of User fields/User Info fields can be equal to the number of allocated RUs/MRUs, and information in each RU/MRU can be indicated to the corresponding STA.

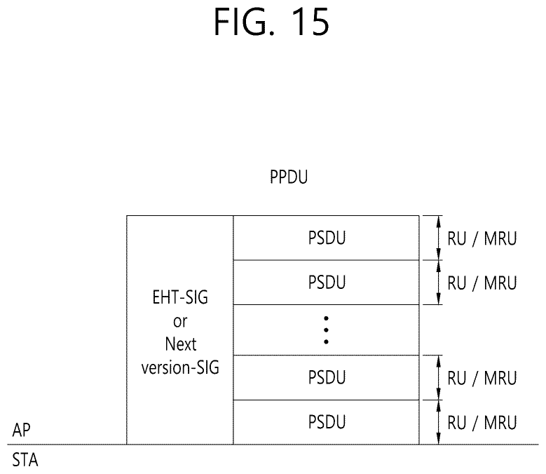

FIG. 15 shows an example of transmitting multiple PSDUs to one STA based on an MU PPDU according to the present embodiment.

Referring to FIG. 15, an AP transmits multiple PSDUs to one STA based on MU PPDU. At this time, since MU PPDU is used, a User field for the one STA exists in EHT-SIG (or Next version SIG), and the User field can exist as many times as the number of RUs or MRUs to which multiple PSDUs are allocated. The EHT-SIG (or Next version SIG) includes a Common field including a RU Allocation subfield, and the RU Allocation subfield can indicate the location of the RU or MRU to which each PSDU is allocated. The User field can indicate the MCS to which each PSDU is allocated, the number of streams, whether coding and beamforming are applied, etc.

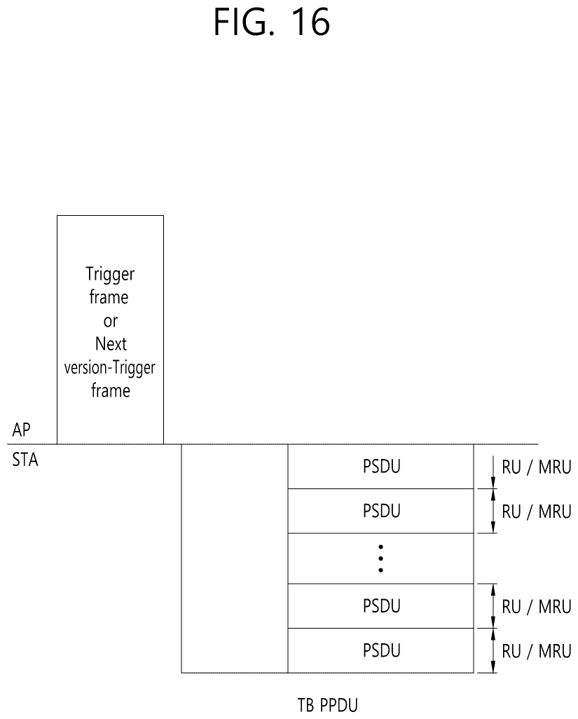

FIG. 16 shows an example of transmitting multiple PSDUs to one STA based on a trigger frame according to the present embodiment.

Referring to FIG. 16, an AP transmits a trigger frame to one STA, and the one STA transmits multiple PSDUs in TB PPDU format based on the trigger frame. At this time, since TB PPDU is used, a User Info field for the one STA exists in the trigger frame (or Next version trigger frame), and the User Info field can exist as many times as the number of RUs or MRUs to which multiple PSDUs are allocated. The User Info field includes a RU Allocation subfield, and the RU Allocation subfield can indicate the location of the RU or MRU to which each PSDU is allocated. In addition, the User Info field can also indicate MCS, the number of streams, whether coding is applied, etc.

Both the AP and STA in FIG. 15 and FIG. 16 transmit and receive the above multiple PSDUs on only one link.

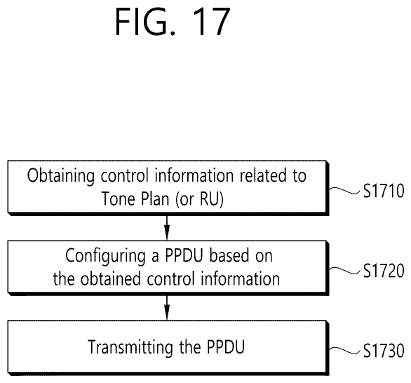

FIG. 17 is a flowchart illustrating the operation of the transmitting apparatus/device according to the present embodiment.

The example of FIG. 17 may be performed by a transmitting device (AP and/or non-AP STA).

Some of each step (or detailed sub-step to be described later) of the example of FIG. 17 may be skipped/omitted.

Through step S1710, the transmitting device (transmitting STA) may obtain information about the above-described tone plan. As described above, the information about the tone plan includes the size and location of the RU, control information related to the RU, information about a frequency band including the RU, information about an STA receiving the RU, and the like.

Through step S1720, the transmitting device may construct/generate a PPDU based on the acquired control information. Configuring/generating the PPDU may include configuring/generating each field of the PPDU. That is, step S1720 includes configuring the EHT-SIG field including control information about the tone plan. That is, step S2020 includes configuring a field including control information (e.g., N bitmap) indicating the size/position of the RU; and/or configuring a field including an identifier of an STA receiving the RU (e.g., AID).

Also, step S1720 may include generating an STF/LTF sequence transmitted through a specific RU. The STF/LTF sequence may be generated based on a preset STF generation sequence/LTF generation sequence.

Also, step S1720 may include generating a data field (i.e., MPDU) transmitted through a specific RU.

The transmitting device may transmit the PPDU constructed through step S1720 to the receiving device based on step S1730.

While performing step S1730, the transmitting device may perform at least one of operations such as CSD, Spatial Mapping, IDFT/IFFT operation, and GI insertion.

A signal/field/sequence constructed according to the present specification may be transmitted in the form of FIG. 10.

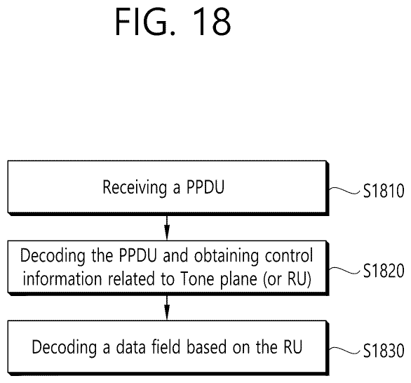

FIG. 18 is a flowchart illustrating the operation of the receiving apparatus/device according to the present embodiment.

The aforementioned PPDU may be received according to the example of FIG. 18.

The example of FIG. 18 may be performed by a receiving apparatus/device (AP and/or non-AP STA).

Some of each step (or detailed sub-step to be described later) of the example of FIG. 18 may be skipped/omitted.

The receiving device (receiving STA) may receive all or part of the PPDU through step S1810. The received signal may be in the form of FIG. 10.

A sub-step of step S1810 may be determined based on step S1730 of FIG. 17. That is, in step S1810, an operation of restoring the result of the CSD, Spatial Mapping, IDFT/IFFT operation, and GI insertion operation applied in step S1730 may be performed.

In step S1820, the receiving device may perform decoding on all/part of the PPDU. Also, the receiving device may obtain control information related to a tone plan (i.e., RU) from the decoded PPDU.

More specifically, the receiving device may decode the L-SIG and EHT-SIG of the PPDU based on the legacy STF/LTF and obtain information included in the L-SIG and EHT SIG fields. Information on various tone plans (i.e., RUs) described in this specification may be included in the EHT-SIG, and the receiving STA may obtain information on the tone plan (i.e., RU) through the EHT-SIG.

In step S1830, the receiving device may decode the remaining part of the PPDU based on information about the tone plan (i.e., RU) acquired through step S1820. For example, the receiving STA may decode the STF/LTF field of the PPDU based on information about one plan (i.e., RU). In addition, the receiving STA may decode the data field of the PPDU based on information about the tone plan (i.e., RU) and obtain the MPDU included in the data field.

In addition, the receiving device may perform a processing operation of transferring the data decoded through step S1830 to a higher layer (e.g., MAC layer). In addition, when generation of a signal is instructed from the upper layer to the PHY layer in response to data transmitted to the upper layer, a subsequent operation may be performed.

Hereinafter, the above-described embodiment will be described with reference to FIG. 1 to FIG. 18.

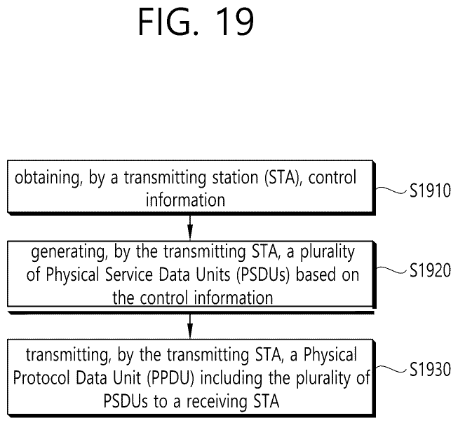

FIG. 19 is a flowchart showing a procedure for transmitting a PPDU including multiple PSDUs to one receiving STA according to the present embodiment.

The example of FIG. 19 may be performed in a network environment in which a next generation WLAN system (IEEE 802.11be or EHT WLAN system) is supported. The next generation wireless LAN system is a WLAN system that is enhanced from an 802.11ax system and may, therefore, satisfy backward compatibility with the 802.11ax system.

The example of FIG. 19 is performed in a transmitting STA, and the transmitting STA may correspond to an access point (AP) STA. The receiving STA may correspond to a non-AP STA.

This embodiment proposes a method of allocating RUs or MRUs to each of a plurality of PSDUs when one receiving STA transmits the plurality of PSDUs on one link or when the plurality of PSDUs are transmitted to one receiving STA.

In step S1910, a transmitting station (STA) obtains control information.

In step S1920, the transmitting STA generates a plurality of Physical Service Data Units (PSDUs) based on the control information.

In step S1930, the transmitting STA transmits a Physical Protocol Data Unit (PPDU) including the plurality of PSDUs to a receiving STA.

The plurality of PSDUs are transmitted simultaneously on a single link. That is, it is assumed that the transmitting and receiving STAs are capable of only single link operation (not multi-link operation).

The control information includes information on a plurality of Resource Units (RUs) or Multi-Resource Units (MRUs) to which the plurality of PSDUs are respectively allocated within a bandwidth of the PPDU. For example, it is assumed that the plurality of PSDUs include first to third PSDUs, and the plurality of RUs or MRUs include first to third RUs or MRUs. The first PSDU may be allocated to the first RU or MRU, the second PSDU may be allocated to the second RU or MRU, and the third PSDU may be allocated to the third RU or MRU.

The plurality of RUs or MRUs are allocated only within a channel within an operating bandwidth of the receiving STA. That is, the plurality of RUs or MRUs may be allocated only within a channel on which the receiving STA operates within the bandwidth of the PPDU.

The plurality of RUs or MRUs are allocated only to the receiving STA, the receiving STA is one STA. Since no STA other than the one STA can be assigned to the plurality of RUs or MRUs, Multi User-Multi Input Multi Output (MU-MIMO) may not be applied to the multiple RUs or MRUs.

Each of the plurality of RUs or MRUs may be adjacent to each other. Additionally, the plurality of RUs or MRUs may be consecutive to each other. If some of the plurality of RUs or MRUs are discontinuous, no receiving STA may be allocated to the resources (RUs or MRUs) between the discontinuous RUs or MRUs.

Based on the PPDU being a Multi-User (MU) PPDU, the control information may include a signal field. The signal field may include a common field and a user field for the receiving STA. The signal field may be an Extreme High Throughput-Signal (EHT-SIG) field or a Next version-SIG field.

The user field may exist as many as a number of the plurality of RUs or MRUs. For example, based on the number of the plurality of RUs or MRUs being three, the user field may include first to third user fields. The first to third user fields may be sequentially positioned after the common field,

In the plurality of RUs or MRUs, a Modulation and Coding Scheme (MCS), a number of streams, coding, and beamforming may be all applied equally.

For example, only the first user field may include information on the MCS, the number of streams, the coding and the beamforming. In the second and third user fields, the information on the MCS, the number of streams, the coding and the beamforming may be reserved. The third user field may include only information indicating that it is the last user field or information on a number of the user fields.

As another example, only the first user field may include information on the MCS, the number of streams, the coding and the beamforming. In the second and third user fields, the information on the MCS, the number of streams, the coding and the beamforming may be reserved. A reserved bit of the first user field may include information indicating that the first user field is the last user field. The reserved bit is set to B15.

In addition, the PPDU may include a Short Training Field (STF) and a Long Training Field (LTF). The receiving STA may perform Automatic Gain Control (AGC) through the STF and perform channel estimation based on the LTF, thereby easily operating to decode the plurality of PSDUs.

Based on the PPDU being a Trigger Based (TB) PPDU, the control information may be included in a trigger frame. That is, the transmitting STA transmits the trigger frame to the receiving STA, and the transmitting STA can receive the PPDU from the receiving STA based on the trigger frame. The trigger frame may include a common information field and a user information field for the receiving STA.

The user information field exists as many as a number of the plurality of RUs or MRUs. For example, based on the number of the plurality of RUs or MRUs being 3, the user information field may include first to third user information fields.

In the plurality of RUs or MRUs, a MCS, a number of streams, coding, and beamforming may be all applied equally.

For example, only the first user information field may include information on the MCS, the number of streams, the coding, and the beamforming. In the second and third user information fields, the information on the MCS, the number of streams, the coding, and the beamforming may be reserved. The third user information field may include only information indicating that it is the last user information field or information on a number of the user information fields.

That is, the present embodiment proposes a method of setting an RU or MRU for allocating the plurality of PSDUs when one receiving STA transmits the plurality of PSDUs simultaneously or when the plurality of PSDUs are transmitted simultaneously to one receiving STA. In the past, there was a limitation that a single receiving STA could not simultaneously transmit and receive a plurality of PSDUs through a single link. According to the embodiment proposed in this specification, by allocating a plurality of RUs or MRUs for a transmitting STA to simultaneously transmit and receive the plurality of PSDUs, the channel can be used more efficiently, and the utilization and efficiency of the channel can be improved.

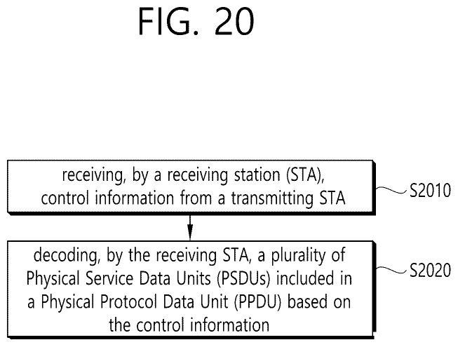

FIG. 20 is a flowchart showing a procedure for receiving a PPDU including multiple PSDUs from a transmitting STA according to the present embodiment.

The example of FIG. 20 may be performed in a network environment in which a next generation WLAN system (IEEE 802.11be or EHT WLAN system) is supported. The next generation wireless LAN system is a WLAN system that is enhanced from an 802.11ax system and may, therefore, satisfy backward compatibility with the 802.11ax system.

The example of FIG. 20 is performed in a receiving STA, and the receiving STA may correspond to non-access point (a non-AP) STA. The transmitting STA may correspond to an AP STA.

This embodiment proposes a method of allocating RUs or MRUs to each of a plurality of PSDUs when one receiving STA transmits the plurality of PSDUs on one link or when the plurality of PSDUs are transmitted to one receiving STA.

In step S2010, a receiving station (STA) receives control information from a transmitting STA.

In step S2020, the receiving STA decodes a plurality of Physical Service Data Units (PSDUs) included in a Physical Protocol Data Unit (PPDU) based on the control information.

The plurality of PSDUs are transmitted simultaneously on a single link. That is, it is assumed that the transmitting and receiving STAs are capable of only single link operation (not multi-link operation).

The control information includes information on a plurality of Resource Units (RUs) or Multi-Resource Units (MRUs) to which the plurality of PSDUs are respectively allocated within a bandwidth of the PPDU. For example, it is assumed that the plurality of PSDUs include first to third PSDUs, and the plurality of RUs or MRUs include first to third RUs or MRUs. The first PSDU may be allocated to the first RU or MRU, the second PSDU may be allocated to the second RU or MRU, and the third PSDU may be allocated to the third RU or MRU.

The plurality of RUs or MRUs are allocated only within a channel within an operating bandwidth of the receiving STA. That is, the plurality of RUs or MRUs may be allocated only within a channel on which the receiving STA operates within the bandwidth of the PPDU.

The plurality of RUs or MRUs are allocated only to the receiving STA, the receiving STA is one STA. Since no STA other than the one STA can be assigned to the plurality of RUs or MRUs, Multi User-Multi Input Multi Output (MU-MIMO) may not be applied to the multiple RUs or MRUs.

Each of the plurality of RUs or MRUs may be adjacent to each other. Additionally, the plurality of RUs or MRUs may be consecutive to each other. If some of the plurality of RUs or MRUs are discontinuous, no receiving STA may be allocated to the resources (RUs or MRUs) between the discontinuous RUs or MRUs.

Based on the PPDU being a Multi-User (MU) PPDU, the control information may include a signal field. The signal field may include a common field and a user field for the receiving STA. The signal field may be an Extreme High Throughput-Signal (EHT-SIG) field or a Next version-SIG field.

The user field may exist as many as a number of the plurality of RUs or MRUs. For example, based on the number of the plurality of RUs or MRUs being three, the user field may include first to third user fields. The first to third user fields may be sequentially positioned after the common field,

In the plurality of RUs or MRUs, a Modulation and Coding Scheme (MCS), a number of streams, coding, and beamforming may be all applied equally.

For example, only the first user field may include information on the MCS, the number of streams, the coding and the beamforming. In the second and third user fields, the information on the MCS, the number of streams, the coding and the beamforming may be reserved. The third user field may include only information indicating that it is the last user field or information on a number of the user fields.

As another example, only the first user field may include information on the MCS, the number of streams, the coding and the beamforming. In the second and third user fields, the information on the MCS, the number of streams, the coding and the beamforming may be reserved. A reserved bit of the first user field may include information indicating that the first user field is the last user field. The reserved bit is set to B15.

In addition, the PPDU may include a Short Training Field (STF) and a Long Training Field (LTF). The receiving STA may perform Automatic Gain Control (AGC) through the STF and perform channel estimation based on the LTF, thereby easily operating to decode the plurality of PSDUs.

Based on the PPDU being a Trigger Based (TB) PPDU, the control information may be included in a trigger frame. That is, the transmitting STA transmits the trigger frame to the receiving STA, and the transmitting STA can receive the PPDU from the receiving STA based on the trigger frame. The trigger frame may include a common information field and a user information field for the receiving STA.

The user information field exists as many as a number of the plurality of RUs or MRUs. For example, based on the number of the plurality of RUs or MRUs being 3, the user information field may include first to third user information fields.

In the plurality of RUs or MRUs, a MCS, a number of streams, coding, and beamforming may be all applied equally.

For example, only the first user information field may include information on the MCS, the number of streams, the coding, and the beamforming. In the second and third user information fields, the information on the MCS, the number of streams, the coding, and the beamforming may be reserved. The third user information field may include only information indicating that it is the last user information field or information on a number of the user information fields.

That is, the present embodiment proposes a method of setting an RU or MRU for allocating the plurality of PSDUs when one receiving STA transmits the plurality of PSDUs simultaneously or when the plurality of PSDUs are transmitted simultaneously to one receiving STA. In the past, there was a limitation that a single receiving STA could not simultaneously transmit and receive a plurality of PSDUs through a single link. According to the embodiment proposed in this specification, by allocating a plurality of RUs or MRUs for a transmitting STA to simultaneously transmit and receive the plurality of PSDUs, the channel can be used more efficiently, and the utilization and efficiency of the channel can be improved.

### 4. Device Configuration

The technical features of the present disclosure may be applied to various devices and methods. For example, the technical features of the present disclosure may be performed/supported through the device(s) of FIG. 1 and/or FIG. 11. For example, the technical features of the present disclosure may be applied to only part of FIG. 1 and/or FIG. 11. For example, the technical features of the present disclosure may be implemented based on the processing chip(s) 114 and 124 of FIG. 1, or implemented based on the processor(s) 111 and 121 and the memory(s) 112 and 122, or implemented based on the processor 610 and the memory 620 of FIG. 11. For example, the device according to the present disclosure receives control information from a transmitting station (STA); and decodes a plurality of Physical Service Data Units (PSDUs) included in a Physical Protocol Data Unit (PPDU) based on the control information.

The technical features of the present disclosure may be implemented based on a computer readable medium (CRM). For example, a CRM according to the present disclosure is at least one computer readable medium including instructions designed to be executed by at least one processor.

The CRM may store instructions that perform operations including receiving control information from a transmitting station (STA); and decoding a plurality of Physical Service Data Units (PSDUs) included in a Physical Protocol Data Unit (PPDU) based on the control information. At least one processor may execute the instructions stored in the CRM according to the present disclosure. At least one processor related to the CRM of the present disclosure may be the processor 111, 121 of FIG. 1, the processing chip 114, 124 of FIG. 1, or the processor 610 of FIG. 11. Meanwhile, the CRM of the present disclosure may be the memory 112, 122 of FIG. 1, the memory 620 of FIG. 11, or a separate external memory/storage medium/disk.

The foregoing technical features of the present specification are applicable to various applications or business models. For example, the foregoing technical features may be applied for wireless communication of a device supporting artificial intelligence (AI).

Artificial intelligence refers to a field of study on artificial intelligence or methodologies for creating artificial intelligence, and machine learning refers to a field of study on methodologies for defining and solving various issues in the area of artificial intelligence. Machine learning is also defined as an algorithm for improving the performance of an operation through steady experiences of the operation.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value.

The artificial neural network may include an input layer, an output layer, and optionally one or more hidden layers. Each layer includes one or more neurons, and the artificial neural network may include synapses that connect neurons. In the artificial neural network, each neuron may output a function value of an activation function of input signals input through a synapse, weights, and deviations.

A model parameter refers to a parameter determined through learning and includes a weight of synapse connection and a deviation of a neuron. A hyper-parameter refers to a parameter to be set before learning in a machine learning algorithm and includes a learning rate, the number of iterations, a mini-batch size, and an initialization function.

Learning an artificial neural network may be intended to determine a model parameter for minimizing a loss function. The loss function may be used as an index for determining an optimal model parameter in a process of learning the artificial neural network.

Machine learning may be classified into supervised learning, unsupervised learning, and reinforcement learning.

Supervised learning refers to a method of training an artificial neural network with a label given for training data, wherein the label may indicate a correct answer (or result value) that the artificial neural network needs to infer when the training data is input to the artificial neural network. Unsupervised learning may refer to a method of training an artificial neural network without a label given for training data. Reinforcement learning may refer to a training method for training an agent defined in an environment to choose an action or a sequence of actions to maximize a cumulative reward in each state.

Machine learning implemented with a deep neural network (DNN) including a plurality of hidden layers among artificial neural networks is referred to as deep learning, and deep learning is part of machine learning. Hereinafter, machine learning is construed as including deep learning.

The foregoing technical features may be applied to wireless communication of a robot.

Robots may refer to machinery that automatically process or operate a given task with own ability thereof. In particular, a robot having a function of recognizing an environment and autonomously making a judgment to perform an operation may be referred to as an intelligent robot.

Robots may be classified into industrial, medical, household, military robots and the like according uses or fields. A robot may include an actuator or a driver including a motor to perform various physical operations, such as moving a robot joint. In addition, a movable robot may include a wheel, a brake, a propeller, and the like in a driver to run on the ground or fly in the air through the driver.

The foregoing technical features may be applied to a device supporting extended reality.

Extended reality collectively refers to virtual reality (VR), augmented reality (AR), and mixed reality (MR). VR technology is a computer graphic technology of providing a real-world object and background only in a CG image, AR technology is a computer graphic technology of providing a virtual CG image on a real object image, and MR technology is a computer graphic technology of providing virtual objects mixed and combined with the real world.

MR technology is similar to AR technology in that a real object and a virtual object are displayed together. However, a virtual object is used as a supplement to a real object in AR technology, whereas a virtual object and a real object are used as equal statuses in MR technology.

XR technology may be applied to a head-mount display (HMD), a head-up display (HUD), a mobile phone, a tablet PC, a laptop computer, a desktop computer, a TV, digital signage, and the like. A device to which XR technology is applied may be referred to as an XR device.

The claims recited in the present specification may be combined in a variety of ways. For example, the technical features of the method claims of the present specification may be combined to be implemented as a device, and the technical features of the device claims of the present specification may be combined to be implemented by a method. In addition, the technical characteristics of the method claim of the present specification and the technical characteristics of the device claim may be combined to be implemented as a device, and the technical characteristics of the method claim of the present specification and the technical characteristics of the device claim may be combined to be implemented by a method.

1. A method in a wireless local area network (WLAN) system, the method comprising:
receiving, by a receiving station (STA), control information from a transmitting STA; and
decoding, by the receiving STA, a plurality of Physical Service Data Units (PSDUs) included in a Physical Protocol Data Unit (PPDU) based on the control information,
wherein the plurality of PSDUs are transmitted simultaneously on a single link,
wherein the control information includes information on a plurality of Resource Units (RUs) or Multi-Resource Units (MRUs) to which the plurality of PSDUs are respectively allocated within a bandwidth of the PPDU, and
wherein the plurality of RUs or MRUs are allocated only within a channel within an operating bandwidth of the receiving STA.

2. The method of claim 1, wherein the plurality of RUs or MRUs are allocated only to the receiving STA, the receiving STA is one STA,
wherein Multi User-Multi Input Multi Output (MU-MIMO) is not applied to the multiple RUs or MRUs,
wherein each of the plurality of RUs or MRUs is adjacent to each other.

3. The method of claim 1, wherein based on the PPDU being a Multi-User (MU) PPDU, the control information includes a signal field,
wherein the signal field includes a common field and a user field for the receiving STA,
wherein the user field exists as many as a number of the plurality of RUs or MRUs,
wherein based on the number of the plurality of RUs or MRUs being three, the user field includes first to third user fields,
wherein the first to third user fields are sequentially positioned after the common field,
wherein the signal field is an Extreme High Throughput-Signal (EHT-SIG) field or a Next version-SIG field.

4. The method of claim 3, wherein in the plurality of RUs or MRUs, a Modulation and Coding Scheme (MCS), a number of streams, coding, and beamforming are all applied equally.

5. The method of claim 4, wherein only the first user field includes information on the MCS, the number of streams, the coding and the beamforming,
wherein in the second and third user fields, the information on the MCS, the number of streams, the coding and the beamforming is reserved,
wherein the third user field includes only information indicating that it is the last user field or information on a number of the user fields.

6. The method of claim 4, wherein only the first user field includes information on the MCS, the number of streams, the coding and the beamforming,
wherein in the second and third user fields, the information on the MCS, the number of streams, the coding and the beamforming is reserved,
wherein a reserved bit of the first user field includes information indicating that the first user field is the last user field,
wherein the reserved bit is set to B15.

7. The method of claim 1, wherein based on the PPDU being a Trigger Based (TB) PPDU, the control information is included in a trigger frame,
wherein the trigger frame includes a common information field and a user information field for the receiving STA,
wherein the user information field exists as many as a number of the plurality of RUs or MRUs,
wherein based on the number of the plurality of RUs or MRUs being 3, the user information field includes first to third user information fields,
wherein in the plurality of RUs or MRUs, a MCS, a number of streams, coding, and beamforming are all applied equally,
wherein only the first user information field includes information on the MCS, the number of streams, the coding, and the beamforming,
wherein in the second and third user information fields, the information on the MCS, the number of streams, the coding, and the beamforming are reserved,
wherein the third user information field includes only information indicating that it is the last user information field or information on a number of the user information fields.

8. A receiving station (STA) in a wireless local area network (WLAN) system, the receiving STA comprising:
a memory;
a transceiver; and
a processor being operatively connected to the memory and the transceiver,
wherein the processor is configured to:
receive control information from a transmitting STA; and
decode a plurality of Physical Service Data Units (PSDUs) included in a Physical Protocol Data Unit (PPDU) based on the control information,
wherein the plurality of PSDUs are transmitted simultaneously on a single link,
wherein the control information includes information on a plurality of Resource Units (RUs) or Multi-Resource Units (MRUs) to which the plurality of PSDUs are respectively allocated within a bandwidth of the PPDU, and
wherein the plurality of RUs or MRUs are allocated only within a channel within an operating bandwidth of the receiving STA.

9. A method in a wireless local area network (WLAN) system, the method comprising:
obtaining, by a transmitting station (STA), control information;
generating, by the transmitting STA, a plurality of Physical Service Data Units (PSDUs) based on the control information; and
transmitting, by the transmitting STA, a Physical Protocol Data Unit (PPDU) including the plurality of PSDUs to a receiving STA,
wherein the plurality of PSDUs are transmitted simultaneously on a single link,
wherein the control information includes information on a plurality of Resource Units (RUs) or Multi-Resource Units (MRUs) to which the plurality of PSDUs are respectively allocated within a bandwidth of the PPDU, and
wherein the plurality of RUs or MRUs are allocated only within a channel within an operating bandwidth of the receiving STA.

10. The method of claim 9, wherein the plurality of RUs or MRUs are allocated only to the receiving STA, the receiving STA is one STA,
wherein Multi User-Multi Input Multi Output (MU-MIMO) is not applied to the multiple RUs or MRUs,
wherein each of the plurality of RUs or MRUs is adjacent to each other.

11. The method of claim 9, wherein based on the PPDU being a Multi-User (MU) PPDU, the control information includes a signal field,
wherein the signal field includes a common field and a user field for the receiving STA,
wherein the user field exists as many as a number of the plurality of RUs or MRUs,
wherein based on the number of the plurality of RUs or MRUs being three, the user field includes first to third user fields,
wherein the first to third user fields are sequentially positioned after the common field,
wherein the signal field is an Extreme High Throughput-Signal (EHT-SIG) field or a Next version-SIG field.

12. The method of claim 11, wherein in the plurality of RUs or MRUs, a Modulation and Coding Scheme (MCS), a number of streams, coding, and beamforming are all applied equally.

13. The method of claim 12, wherein only the first user field includes information on the MCS, the number of streams, the coding and the beamforming,
wherein in the second and third user fields, the information on the MCS, the number of streams, the coding and the beamforming is reserved,
wherein the third user field includes only information indicating that it is the last user field or information on a number of the user fields.

14. The method of claim 12, wherein only the first user field includes information on the MCS, the number of streams, the coding and the beamforming,
wherein in the second and third user fields, the information on the MCS, the number of streams, the coding and the beamforming is reserved,
wherein a reserved bit of the first user field includes information indicating that the first user field is the last user field,
wherein the reserved bit is set to B15.

15. The method of claim 9, wherein based on the PPDU being a Trigger Based (TB) PPDU, the control information is included in a trigger frame,
wherein the trigger frame includes a common information field and a user information field for the receiving STA,
wherein the user information field exists as many as a number of the plurality of RUs or MRUs,
wherein based on the number of the plurality of RUs or MRUs being 3, the user information field includes first to third user information fields,
wherein in the plurality of RUs or MRUs, a MCS, a number of streams, coding, and beamforming are all applied equally,
wherein only the first user information field includes information on the MCS, the number of streams, the coding, and the beamforming,
wherein in the second and third user information fields, the information on the MCS, the number of streams, the coding, and the beamforming are reserved,
wherein the third user information field includes only information indicating that it is the last user information field or information on a number of the user information fields.

16.-18. (canceled)
